(19) United States
(12) Patent Application Publication
(10) Pub. No.: US 2010/0115109 A1
(43) Pub. Date: May 6, 2010

(54) COMMUNICATION CONTINUING METHOD AND COMMUNICATION TERMINAL DEVICE USED IN THE METHOD

(75) Inventors: Tetsuro Morimoto, Kanagawa (JP); Takashi Aramaki, Osaka (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/518,603

(22) PCT Filed: Dec. 7, 2007
(86) PCT No.: PCT/JP2007/073709

§ 371 Date: Jun. 10, 2009

(30) Foreign Application Priority Data
Dec. 11, 2006 (JP) 2006-333720
Mar. 29, 2007 (JP) 2007-087846

(51) Int. Cl. G06F 15/16

(52) U.S. Cl. 709/228

(57) ABSTRACT

A technology is disclosed for providing a communication continuing method and the like that can shorten an amount of time required to complete message exchange for changing addresses of both ends of the SA, and efficiently perform the message exchange, without increasing the number of messages. In the technology, a step at which the second communication terminal sends the first message to the first communication terminal in accompaniment with movement of the second communication terminal itself is included, the first message requesting an update of an address in security information held by the first communication terminal. A step at which the first communication terminal sends the second message to an address of the second communication terminal before movement in accompaniment with movement of the first communication terminal itself, and sends the third message to an address of the second communication terminal after movement when the first message is received before a response to the second message is received is also included, the second message requesting an update of an address in security information held by the second communication terminal and the third message requesting an update of an address in the security information held by the second communication terminal.

### TECHNICAL FIELD

The present invention relates to a communication continuing method and a communication terminal device used in the method in which, when an address changes as a result of movement of a communication terminal device after security information used to establish a secure communication path between communication terminal devices is generated, communication between the communication terminal devices after the movement continues with the security information generated before the movement.

### BACKGROUND ART

Internet Engineering Task Force (IETF) developed MOBIKE protocol (refer to Non-patent Document 2, below) which is mobility and multihoming extension to Internet Key Exchange version 2 (IKEv2; refer to Non-Patent Document 1, below). MOBIKE is a protocol that the terminal does not need to establish new IKE Security Associations (SAs) and IPsec SAs, when it moves and the IP address of it changes or when it obtains new IP addresses for multihoming.

If a terminal does not use MOBIKE protocol, for example, the terminal is required to re-establish IKE SAs and IPsec SAs from the first step of the SA establishing process when either of the terminals that are both sides of the SAs changes its IP address for moving or the like. The IKEv2 process of establishing SAs, including a mutual authentication process and the like, is a high-load process. On the other hand, when the terminal uses MOBIKE protocol, it is required only to change the IP address of SAs, and it does not need any authentication process for establishing the SA and making new keys. Therefore, processing accompanying IP addresses change can be significantly reduced. An operation based on the MOBIKE protocol performed when an IP address is changed due to movement and the like will be described with reference to FIG. 24.

First, an initial state in which an SA is established between a terminal I and a terminal R is assumed. Character “I” of the terminal I refers to an initiator and indicates a side that sends a MOBIKE message. Character “R” of the terminal R refers to a responder and indicates a side that receives a request message. At the time that the terminal I moves and changes the IP address, the terminal I sends a message (address change request message) 2401 (FIG. 25A) to the terminal R. The message 2401 gives notification of a change in the address. In the address change request message 2401, a source address is the new address (IP_I_new) of the terminal I, and a destination address is the address (IP_R) of the terminal R. The address change request message 2401 includes N(UPDATE_SA_ADDRESSES) that is information indicating that this is a request to change the address of the SA. The information elements, N(NAT_DETECTION_SOURCE_IP) and N(NAT_DETECTION_DESTINATION_IP) are included in the address change request message 2401, which are defined in IKEv2 specification and used for checking whether IP addresses are changed or not by network address translation (NAT).

When the terminal R has received the request to change the address of the SA in the address change request message 2401, the terminal R changes (replaces) the information of an old address of the terminal I of the SA to a new address using a source IP address within an IP header. The terminal R then sends a response message 2402 (FIG. 25B). In the response message 2402, the source address is the address of the terminal R (IP_R), and the destination address is the new address (IP_I_new) of the terminal I. Like the address change request message 2401, the response message 2402 includes N(NAT_DETECTION_SOURCE_IP) and N(NAT_DETECTION_DESTINATION_IP) for checking whether IP addresses are changed or not by NAT.

Basically, the SA can be continuously used by the terminal R being notified of the change in the address of the terminal I, and the IP address of the SA used between the terminal I and the terminal R being changed, by the above-described address change request message 2401 and response message 2402. In MOBIKE protocol, a message 2403 (FIG. 25C) and a message 2404 (FIG. 25D) for confirmation, to be used after the address change request message 2401 and the response message 2402, are also prescribed. The message 2403 and the message 2404 allow the terminal R to send a message to the new IP address (IP_I_new) of the terminal I and confirm whether a response is received. This confirmation process is not required to be performed. An overview of MOBIKE protocol, known as a conventional technology, is as described above.

### Non-patent Document 1: “IKEv2 Mobility and Multihoming Protocol (MOBIKE)”, RFC4555, June 2006

Non-patent Document 2: “Internet Key Exchange (IKEv2) protocol”, RFC4306, December 2005

When the conventional technology MOBIKE protocol is used, terminals between which an SA is established can easily change IP addresses. However, while the IP address of one end can be efficiently changed using MOBIKE protocol, when both IP addresses of the SA are changed, the IP addresses are required to be changed one at a time. Therefore, the addresses cannot be efficiently changed. For example, an instance will be described with reference to FIG. 26 in which an SA is established between a terminal A and a terminal B, both the terminal A and the terminal B move almost simultaneously, and the terminal A and the terminal B each send an address change request message to the other. An old address of the terminal A is referred to as address Old A, and a new address is referred to as address A. An old address of the terminal B is referred to as address Old B, and a new address is referred to as address B.

The terminal A sends the address change request message to the old address of the terminal B. The terminal B also sends the address change request message to the old address of the terminal A. Therefore, neither message reaches the communication partner. The addresses cannot be changed. In an instance such as this, a method can be considered in which the terminal A and the terminal B each re-send the address change request message to the other. After the address change request messages are re-sent a number of times, the new address of the communication partner is obtained through some means. The request message is then re-sent to the new address. Domain Name Service (DNS) and the like can be considered as a method of acquiring the new address.

Here, an instance can be considered in which the terminal A or the terminal B, or both terminal A and terminal B prepare to forward messages sent to the old address to the new address, to avoid a situation such as that described above. A method using a home agent of a mobile IP, for example, can be considered as a forwarding method. An operation performed when, for example, only the terminal A prepares to forward the messages addressed to the old address to the new address, when the conventional MOBIKE protocol is used, will be described with reference to FIG. 27.

The terminal A and the terminal B almost simultaneously send the address change request messages. The address change request message sent by the terminal A is sent to the old address of the terminal B and is discarded without reaching the terminal B. On the other hand, the address change request message sent by the terminal B is forwarded from the old address to the new address of the terminal A, and reaches the terminal A. The terminal A sends a response message to the terminal B. At this time, the response message is sent such that the source address of the response message is the same as the destination address of the address change request message from the terminal B. For example, the response message is sent via the home agent. After the response message is sent, the terminal A re-sends the address change request message to the terminal B. Unlike the previous message, the address change request message is sent to the new address of the terminal B. The terminal B returns a response to the address change request from the terminal A. Through these processes, the first step is to change the address of the terminal B, and the second step is to change the address of the terminal A. The processes are actualized by the conventional MOBIKE protocol.

Next, an operation performed when, in addition to the terminal A, the terminal B also prepares to forward the messages addressed to the old address to the new address will be described with reference to FIG. 28. In this instance, from the perspective of the terminal A, the terminal A can know that the address of the terminal B is new by the address change request message from the terminal B. The terminal A can also know that information regarding the change in address of the terminal A has reached the terminal B by receiving the response message from the terminal B. In other words, when the response message from the terminal B is received, the IP addresses of both ends of the SA can be changed. This method is considered to actualize address changes on both ends with considerable efficiency, without requiring redundant messages.

However, the terminal A cannot know whether the terminal B, like the terminal A, is going to forward the messages addressed to the old address to the new address of the terminal B. When the address change request message from the terminal B is received, and the terminal A has already sent the address change request message to the old address of the terminal B, and a response message has yet to be returned, a possibility can be considered that the message has not reached the terminal B. To prevent the terminal A from sending a redundant message, the terminal A preferably waits for the response message from the terminal B. However, despite the terminal A's waiting, the response message may not arrive. The address change request message previously sent by the terminal A may not have reached the terminal B, at the time the terminal A receives the address change request message from the terminal B. Therefore, an appropriate operation may be re-sending of the address change request message immediately after sending of the response message, without waiting for the response message from the terminal B. In this instance, the messages are sent as shown in FIG. 29.

Because the terminal B also operates in the same manner as the terminal A, when both the terminal A and the terminal B forward the messages addressed to the old addresses to the new addresses, the number of messages clearly increases, as shown in FIG. 30. An excessive amount of time is required to complete message exchange for address change of the SA.

In this way, in an address changing method for an SA using the conventional MOBIKE protocol, an issue is present in that it is difficult to change the addresses in the SA efficiently regardless of a communication partner not having a function for forwarding messages addressed to an old address to a new address or a forwarding method being provided.

### DISCLOSURE OF THE INVENTION

The present invention has been achieved in light of the above-described issues. An object of the present invention is to provide a communication continuing method and a communication terminal device used in the method in which, regardless of whether a communication partner has a function for forwarding messages addressed to an old address to a new address, the number of messages is not increased, an amount of time required to complete message exchange for changing addresses of both ends of an SA is shortened, and the message exchange is efficiently performed. In changing an address by conventional MOBIKE protocol, changing addresses in the SA is successively performed for one address at a time. However, an objective of, the present invention is to provide a communication continuing message and a communication terminal device used in the method in which the addresses of both end terminals are more easily collectively changed at once, and an SA address change operation in a terminal is efficiently actualized.

To achieve the above-described objective, the present invention provides a communication continuing method in which, when addresses change as a result of movement of the first communication terminal and the second communication terminal after security information used to establish a secure communication path between the first communication terminal and the second communication terminal is generated, communication between the first communication terminal and the second communication terminal after the movement is continued using the security information generated before the movement. The communication continuing method includes a step at which the second communication terminal sends the first message to the first communication terminal in accompaniment with movement of the second communication terminal itself. The first message requests an update of an address in the security information held by the first communication terminal. The communication continuing method also includes a step at which the first communication terminal sends the second message to the second communication terminal in accompaniment with movement of the first communication terminal itself. The second message requests an update of an address in the security information held by the second communication terminal. When the first message is received before a response to the second message is received, the first communication terminal sends the third message to the address of the second communication terminal after movement. The third message requests an update of an address in the security information held by the second communication terminal. As a result of the configuration, an amount of time required to complete message exchange for changing addresses of both ends of the SA can be shortened, and the message exchange can be efficiently performed, without increasing the number of messages. The security information is equivalent to SA.

In addition, in the communication continuing method of the present invention, a preferred aspect of the present invention is that the third message includes information stating that it is the re-sending message of the second message, information stating that the third message is a response to the first message, and information stating that the third message is a new message requesting an update of an address in the security information held by the second communication terminal. As a result of the configuration, a communication terminal that has received the third message can easily process the message.

The present invention provides a communication continuing method in which, when addresses change as a result of movement of the first communication terminal and the second communication terminal after security information used to establish a secure communication path between the first communication terminal and the second communication terminal is generated, communication between the first communication terminal and the second communication terminal after the movement is continued using the security information generated before the movement. The communication continuing method includes a step at which the second communication terminal sends the first message to the first communication terminal in accompaniment with movement of the second communication terminal itself. The first message requests an update of an address in the security information held by the first communication terminal. The communication continuing method also includes a step at which the first communication terminal sends the second message to the address of the second communication terminal after movement based on the first message. The second message requests an update of an address in the security information held by the second communication terminal. The communication continuing method also includes a step at which the second communication terminal decides not to perform a response process for the second message when the third message requesting an update of an address in the security information held by the second communication terminal is already received from the first communication terminal when the second message is received. The second communication terminal processes the second message as a response to the first message. As a result of the configuration, an amount of time required to complete message exchange for changing addresses of both ends of the SA can be shortened, and the message exchange can be efficiently performed, without increasing the number of messages.

In addition, in the communication continuing method of the present invention, a preferred aspect of the present invention is that the second communication terminal generates a response message based on the second message and sends the generated response message to an address of the first communication terminal after movement, when the third message has not been received from the first communication terminal when the second message is received. As a result of the configuration, a response to the second message can be quickly communicated.

The present invention provides a communication continuing method in which, when addresses change as a result of movement of the first communication terminal and the second communication terminal after security information used to establish a secure communication path between the first communication terminal and the second communication terminal is generated, communication between the first communication terminal and the second communication terminal after the movement is continued using the security information generated before the movement. The communication continuing method includes a step at which the second communication terminal sends the first message to the first communication terminal in accompaniment with movement of the second communication terminal itself. The first message requests an update of an address in the security information held by the first communication terminal. The communication continuing method also includes a step at which the first communication terminal sends the second message to the address of the second communication terminal after movement based on the first message. The second message requests an update of an address in the security information held by the second communication terminal. As a result of the configuration, an amount of time required to complete message exchange for changing addresses of both ends of the SA can be shortened, and the message exchange can be efficiently performed, without increasing the number of messages.

In addition, in the communication continuing method of the present invention, a preferred aspect of the present invention is that the second message includes information stating that the second message is a response to the first message. As a result of the configuration, the number of messages can be suppressed.

In addition, in the communication continuing method of the present invention, a preferred aspect of the present invention is that the second message includes information stating that the request to update the address made by the first message is rejected. As a result of the configuration, the address information of both communication terminals can be simultaneously changed.

In addition, in the communication continuing method of the present invention, a preferred aspect of the present invention is that the second message does not include information related to the first message. As a result of the configuration, processing load can be reduced.

The present invention provides a communication continuing method in which, when an address changes as a result of movement of the second communication terminal after security information used to establish a secure communication path between the first communication terminal capable of multi-linking and the second communication terminal is generated, communication between the first communication terminal and the second communication terminal after the movement is continued using the security information generated before the movement. The communication continuing method includes a step at which the second communication terminal sends the first message to the first communication terminal in accompaniment with movement of the second communication terminal itself. The first message requests an update of an address in the security information held by the first communication terminal. The communication controlling method also includes a step at which the first communication terminal decides whether to update the address in the security information held by the first communication terminal based on the first message. When the address is updated, the first communication terminal updates the address in the security information held by the first communication terminal and sends the second message to the address of the second communication terminal after movement. The second message requests an update of an address in the security information held by the second communication terminal. As a result of the configuration, an amount of time required to complete message exchange for changing addresses of both ends of the SA can be shortened, and the message exchange can be efficiently performed, without increasing the number of messages.

In addition, in the communication continuing method of the present invention, a preferred aspect of the present invention is that the second message includes information stating that the second message is a response to the first message. As a result of the configuration, the number of messages can be suppressed.

In addition, in the communication continuing method of the present invention, a preferred aspect of the present invention is that the second message includes information stating that the request to update the address made by the first message is rejected. As a result of the configuration, the address information of both communication terminals can be simultaneously changed.

In addition, in the communication continuing method of the present invention, a preferred aspect of the present invention is that the second message does not include information related to the first message. As a result of the configuration, processing load can be reduced.

The present invention provides a communication terminal that is a predetermined communication terminal used in a communication continuing method in which, when addresses change as a result of movement of the predetermined communication terminal and a partner communication terminal communicating with the predetermined communication terminal after security information used to establish a secure communication path between the predetermined communication terminal and the partner communication terminal is generated, communication between the predetermined communication terminal and the partner communication terminal after the movement is continued using the security information generated before the movement. The communication terminal includes a receiving means for receiving the first message from the partner communication terminal. The first message requests an update of an address in the security information held by the predetermined communication terminal itself. The communication terminal also includes a request message generating means for generating the second message in accompaniment with movement of the predetermined communication terminal itself. The second message requests an update of an address in the security information held by the partner communication terminal. The communication terminal also includes sending means for sending the generated second message to the address of the partner communication terminal before movement. When the first message is received via the receiving means before a response to the second message is received, the request message generating means generates the third message requesting an update of an address in the security information held by the partner communication terminal. The sending means sends the generated third message to the address of the partner communication terminal after movement. As a result of the configuration, an amount of time required to complete message exchange for changing addresses of both ends of the SA can be shortened, and the message exchange can be efficiently performed, without increasing the number of messages.

in addition, in the communication terminal of the present invention, a preferred aspect of the present invention is that the third message includes information stating that the third message is a re-sending of the second message, information stating that the third message is a response to the first message, and information stating that the third message is a new message requesting an update of an address in the security information held by the partner communication terminal. As a result of the configuration, a communication terminal that has received the third message can easily process the message.

The present invention provides a communication terminal that is a predetermined communication terminal used in a communication continuing method in which, when addresses change as a result of movement of the predetermined communication terminal and a partner communication terminal communicating with the predetermined communication terminal after security information used to establish a secure communication path between the predetermined communication terminal and the partner communication terminal is generated, communication between the predetermined communication terminal and the partner communication terminal after the movement is continued using the security information created before the movement. The communication terminal includes a request message generating means for generating the first message in accompaniment with movement of the predetermined communication terminal itself. The first message requests an update of an address in the security information held by the partner communication terminal. The communication terminal also includes a sending means for sending the generated first message to the partner communication terminal. The communication terminal also includes a receiving means for receiving the second message sent by the partner communication terminal based on the first message. The second message requests an update of an address in the security information held by the predetermined communication terminal. The communication terminal also includes a processing means for deciding not to perform a response process for the second message when the third message requesting an update of an address in the security information held by the predetermined communication terminal is already received from the partner communication terminal when the second message is received via the receiving means, and processing the second message as a response to the first message. As a result of the configuration, an amount of time required to complete message exchange for changing addresses of both ends of the SA can be shortened, and the message exchange can be efficiently performed, without increasing the number of messages.

In addition, in the communication terminal of the present invention, a preferred aspect of the present invention is that a response message generating means is further included for generating a response message based on the second message, when the third message has not been received from the partner communication terminal when the second message is received via the receiving means. The sending means sends the generated response message to the address of the partner communication terminal after movement. As a result of the configuration, a response to the second message can be quickly communicated.

The present invention provides a communication terminal that is a predetermined communication terminal used in a communication continuing method in which, when addresses change as a result of movement of the predetermined communication terminal and a partner communication terminal communicating with the predetermined communication terminal after security information used to establish a secure communication path between the predetermined communication terminal and the partner communication terminal is generated, communication between the predetermined communication terminal and the partner communication terminal after the movement is continued using the security information created before the movement. The communication terminal includes a receiving means for receiving the first message from the partner communication terminal. The first message requests an update of an address in the security information held by the predetermined communication terminal itself. The communication terminal also includes a request message generating means for generating the second message based on the received first message. The second message requests an update of an address in the security information held by the partner communication terminal. The communication terminal also includes a sending means for sending the generated second message to the address of the partner communication terminal after movement. As a result of the configuration, an amount of time required to complete message exchange for changing addresses of both ends of the SA can be shortened, and the message exchange can be efficiently performed, without increasing the number of messages.

In addition, in the communication terminal of the present invention, a preferred aspect of the present invention is that the second message includes information stating that the second message is a response to the first message. As a result of the configuration, the number of messages can be suppressed.

In addition, in the communication terminal of the present invention, a preferred aspect of the present invention is that the second message includes information stating that the request to update the address made by the first message is rejected. As a result of the configuration, the address information of both communication terminals can be simultaneously changed.

In addition, in the communication terminal of the present invention, a preferred aspect of the present invention is that the second message does not include information related to the first message. As a result of the configuration, processing load can be reduced.

The present invention provides a communication terminal that is a predetermined communication terminal used in a communication continuing method in which, when addresses change as a result of movement of the predetermined communication terminal capable of multi-linking and a partner communication terminal communicating with the predetermined communication terminal after security information used to establish a secure communication path between the predetermined communication terminal and the partner communication terminal is generated, communication between the predetermined communication terminal and the partner communication terminal after the movement is continued using the security information generated before the movement. The communication terminal includes a receiving means for receiving the first message from the partner communication terminal. The first message requests an update of an address in the security information held by the predetermined communication terminal itself. The communication terminal also includes a deciding means for deciding whether to update the address in the security information held by the predetermined communication terminal itself, based on the received first message. The communication terminal also includes an updating means for updating the address in the security information held by the predetermined communication terminal itself, when a decision is made to update the address. The communication terminal also includes a request message generating means for generating the second message requesting an update of an address in the security information held by the partner communication terminal. The communication terminal also includes a sending means for sending the generated second message to the address of the partner communication terminal after movement. As a result of the configuration, an amount of time required to complete message exchange for changing addresses of both ends of the SA can be shortened, and the message exchange can be efficiently performed, without increasing the number of messages.

In addition, in the communication terminal of the present invention, a preferred aspect of the present invention is that the second message includes information stating that the second message is a response to the first message. As a result of the configuration, the number of messages can be suppressed.

In addition, in the communication terminal of the present invention, a preferred aspect of the present invention is that the second message includes information stating that the request to update the address made by the first message is rejected. As a result of the configuration, the address information of both communication terminals can be simultaneously changed.

In addition, in the communication terminal of the present invention, a preferred aspect of the present invention is that the second message does not include information related to the first message. As a result of the configuration, processing load can be reduced.

The present invention provides a communication continuing method in which, when an address changes as a result of movement of the first communication terminal after security information used to establish a secure communication path between the first communication terminal and the second communication terminal is generated, the first communication terminal continues communication via the third communication terminal using the security information before movement. The communication continuing method includes a step at which the first communication terminal sends the first message to the second terminal. The first message requests an update of an address in the security information held by the second communication terminal. The communication continuing method also includes a step at which the third communication terminal sends the second message to an address of the first communication terminal after movement, based on the first message received by the second communication terminal. The second message requests an update of the address in the security information held by the first communication terminal. As a result of the configuration, an amount of time required to complete message exchange for changing addresses of both ends of the SA can be shortened, and the message exchange can be efficiently performed, without increasing the number of messages. For example, the first communication terminal in this instance is equivalent to a UE, described hereafter. The second communication terminal is equivalent to a PDG-A, described hereafter. The third communication terminal is equivalent to a PDG-B, described hereafter.

In addition, in the communication continuing method of the present invention, a preferred aspect of the present invention is that a step is further included, at which the third communication terminal sends the third message requesting an update of an address in the security information held by the first communication terminal to the first communication terminal before movement, when the first communication terminal sends the first message to the second communication terminal. The third communication terminal includes identifying information of the third message in the second message and sends the second message. As a result of the configuration, an amount of time required to complete message exchange for changing addresses of both ends of the SA can be shortened, and the message exchange can be efficiently performed, even when address change requests are simultaneously sent.

In addition, in the communication continuing method of the present invention, a preferred aspect of the present invention is that, when the third message sent by the third communication terminal is forwarded to the first communication terminal after movement, the first communication terminal sends to the third communication terminal the fourth message stating that the fourth message is a response to the third message and is a request to update an address. As a result of the configuration, a notification that a response to the third message has been made can be sent.

The present invention provides a communication terminal that is a predetermined communication terminal used in a communication continuing method in which, when an address changes as a result of movement of the predetermined communication terminal after security information used to establish a secure communication path between the predetermined communication terminal and the first partner communication terminal is generated, the predetermined communication terminal continues communication via the second partner communication terminal using the security information before movement. The communication terminal includes a message generating means for generating the first message requesting an update of an address in the security information held by the first partner communication terminal. The communication terminal also includes a sending means for sending the generated first message to the first partner communication terminal. The communication terminal also includes a receiving means for receiving the second message sent by the second partner communication terminal based on reception of the first message by the first partner communication terminal. The second message requests an update of the address in the security information held by the predetermined communication terminal. As a result of the configuration, an amount of time required to complete message exchange for changing addresses of both ends of the SA can be shortened, and the message exchange can be efficiently performed, without increasing the number of messages. For example, the first partner communication terminal in this instance is equivalent to a PDG-A, described hereafter. The second partner communication terminal is equivalent to a PDG-B, described hereafter.

In addition, in the communication terminal of the present invention, a preferred aspect of the present invention is that the receiving means receives the third message sent by the second partner communication terminal at a movement destination when the first message is sent by the sending means. The third message requests an update of an address in the security information held by the predetermined communication terminal. The message generating means generates the fourth message stating that the fourth message is a response to the third message and is a request to update an address. The sending means sends the generated fourth message to the second partner communication terminal. As a result of the configuration, a notification that a response to the third message has been made can be sent.

The communication continuing method and the communication terminal used in the method are configured as described above. The amount of time required to complete message exchange for changing addresses of both ends of the SA can be shortened, and the message exchange can be efficiently performed, without increasing the number of messages. In addition, addresses of both ends can be more easily collectively changed at once. SA address change operation in a terminal can be efficiently actualized.

### BRIEF DESCRIPTION OF THE DRAWINGS

FIG. 1 is a sequence chart of an example of a sequence when a terminal B cannot forward a message addressed to an old address to a new address, according to the first embodiment of the present invention;

FIG. 2 is a diagram of an example of a format of an IKEv2 header according to the first embodiment of the present invention;

FIG. 3 is a sequence chart of an example of a sequence when the terminal B has received an address change request message 11, according to the first embodiment of the present invention;

FIG. 4 is a diagram of a data format of REQUEST(msgID) and REPLY(msgID) according to the first embodiment of the present invention;

FIG. 5 is a flowchart of an example of a processing flow of a communication node when an address change request message is received, according to the first embodiment of the present invention;

FIG. 6A is a sequence chart of an example of a sequence explaining a relevant message sequence, in an explanation of the processing flow of the communication node according to the first embodiment of the present invention;

FIG. 6B is a sequence chart of example of another sequence explaining a relevant message sequence, in the explanation of the processing flow of the communication node according to the first embodiment of the present invention;

FIG. 6C is a sequence chart of example of another sequence explaining a relevant message sequence, in the explanation of the processing flow of the communication node according to the first embodiment of the present invention;

FIG. 7 is a block diagram of an example of a configuration of the communication node according to the first embodiment of the present invention;

FIG. 8A is a sequence chart of an example of a sequence used to explain effects according to the first embodiment of the present invention;

FIG. 8B is a sequence chart of an example of another sequence used to explain the effects according to the first embodiment of the present invention;

FIG. 9A is a sequence chart of an example of a sequence used to explain the effects according to the first embodiment of the present invention;

FIG. 9B is a sequence chart of an example of another sequence used to explain the effects according to the first embodiment of the present invention;

FIG. 10 is a block diagram of a configuration of a communication network according to the second embodiment of the present invention;

FIG. 11 is a sequence chart of an example of a processing sequence of a message according to the second embodiment of the present invention;

FIG. 12 is a block diagram of an example of a configuration of a communication network according to the third embodiment of the present invention;

FIG. 13 is a diagram of an example of a configuration of PDG and UE assumed in the communication network according to the third embodiment of the present invention;

FIG. 14 is a diagram of an example of a configuration of PDG and UE assumed in the communication network according to the third embodiment of the present invention;

FIG. 15 is a diagram explaining an example of a message flow according to the third embodiment of the present invention;

FIG. 16 is a sequence chart explaining an example of a message flow according to the third embodiment of the present invention;

FIG. 17 is a sequence chart explaining another example of a message flow according to the third embodiment of the present invention;

FIG. 18 is a sequence chart explaining another example of a message flow according to the third embodiment of the present invention;

FIG. 19 is a block diagram of an example of a configuration of a PDG according to the third embodiment of the present invention;

FIG. 20 is a diagram explaining a relationship between a PDG managing server and the PDG according to the third embodiment of the present invention;

FIG. 21 is a diagram explaining when the PDG managing server starts changing the PDG before movement of a UE, according to the third embodiment of the present invention;

FIG. 22A is a flowchart of a portion of an example of an operational flow when the PDG managing server starts changing the PDG before movement of the UE, according to the third embodiment of the present invention;

FIG. 22B is a flowchart of a portion of an example of an operational flow when the PDG managing server starts changing the PDG before movement of the UE, according to the third embodiment of the present invention;

FIG. 23 is a block diagram of a configuration of a PDG when the PDG managing server is not present, according to the third embodiment of the present invention;

FIG. 24 is a diagram explaining a conventional operation of a MOBIKE protocol when an IP address is changed;

FIG. 25A is a diagram of an example of a conventional address change request message;

FIG. 25B is a diagram of an example of a conventional response message;

FIG. 25C is a diagram of an example of a conventional confirmation message;

FIG. 25D is a diagram of an example of a conventional confirmation message;

FIG. 26 is a sequence chart of an example of a sequence explaining when terminals simultaneously move and send an address change request message to each other in a conventional technology;

FIG. 27 is a sequence chart of an example of a sequence explaining a conventional operation using MOBIKE protocol when only a terminal A prepares to forward a message addressed to an old address to a new address;

FIG. 28 is a sequence chart of an example of a sequence explaining a conventional operation when the terminal A and a terminal B prepare to forward a message addressed to an old address to a new address;

FIG. 29 is a sequence chart of an example of a sequence explaining a conventional operation for re-sending an address change request message immediately after sending of a response message, without waiting for a response message from the terminal B; and

FIG. 30 is a sequence chart of an example of a sequence explaining an increase in the number of messages as a result of the terminal A and the terminal B forwarding messages addressed to the old address to the new address, and address change request messages being re-sent.

### BEST MODE FOR CARRYING OUT THE INVENTION

### First Embodiment

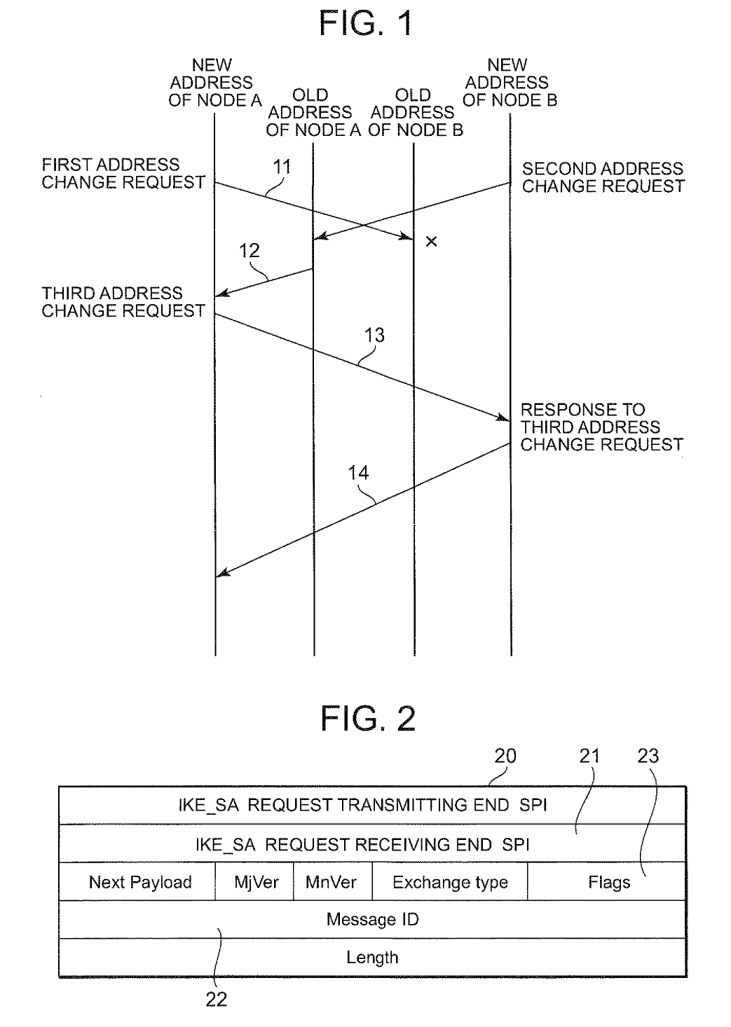

First, the first embodiment of the present invention will be described with reference to FIG. 1. A terminal (also referred to as a device) A and a terminal B establish an IKE SA and an IPsec SA using IKEv2. Moreover, the terminal A and the terminal B are terminals supporting MOBIKE protocol. Before changing an address, the terminal A is set to forward a packet addressed to an old address to a new address. For example, a method can be considered in which the terminal A finds a home agent that can be used on a network before movement and requests that the home agent forward the packet to the new address. First, a protocol operation of the present invention when the terminal B cannot forward a message addressed to an old address to a new address will be described with reference to FIG. 1.

The terminal A issues a notification to the terminal B of an IP address change. Here, an address change request message (first address change request) 11 that is a message being issued is a conventional MOBIKE message. The message includes IPhdr(IP_A_new→IP_B), HDR(msgID_A1), and SK[N(UPDATE_SA_ADDRESSES)]. IPhdr(IP_A_new→IP_B) indicates an IP header of the address change request message 11. A source address is IP_A_new, namely the new address of the terminal A. A destination address is IP_B, namely the address of the terminal B.

HDR indicates an IKEv2 header and has a format such as that shown in FIG. 2. As shown in FIG. 2, the IKEv2 header includes a security parameter index (SPI) 20 and a SPI 21 of a request sending end (initiator) and a request receiving end (responder). The SA can be retrieved based on the information. The IKEv2 header also includes a message identifier (ID) 22. The request sending end uniquely sets the identifier. The request receiving end sets the same message ID in a response message. As a result, when the request sending end receives the response message, the request sending end can identify the address change request message to which the response message corresponds. The message ID of the above-described address change request message 11 is msgID_A1.

An area referred to as flags 23 is present in the IKEv2 header. Within the flags 23, positions of a request sending end bit (initiator bit) and a request receiving end bit (responder bit) are defined. A message in which the initiator bit is standing indicates a message sent by the initiator. On the other hand, a message in which the responder bit is standing indicates a message sent by the responder. In other words, the initiator bit is standing in a request message, and the responder bit is standing in a response message. Whether a message is a request message or a response message can be known during a reception process of the message by the flags 23 area being checked.

SK[ . . . ] indicates a data section concealed by the IKE SA. To decrypt the data section, a value of a SPI set by both communicating terminals is required to be read from the IKEv2 header, a corresponding IKE SA is required to be judged, and a key corresponding to the SA is required to be retrieved from the SA database. The encrypted data section is decrypted using the retrieved key. N(UPDATE_SA_ADDRESSES) is included in the encrypted data section.

N(UPDATE_SA_ADDRESSES) indicates to update of address information of the SA. In other words, N(UPDATE_SA_ADDRESSES) indicates to update of an address of a communication partner of the IKE SA to IP_A_new that is the source address included in the IP header. Information of the IKE SA includes the IP addresses and the SPI information of both ends performing the communication, and key information. When data is encrypted, the SA is identified using the IP address of a sending partner, a source IP address of the terminal itself, and the SPI values set by each terminal. From the SA, a corresponding key is retrieved, and the data is encrypted using the key. When the data is decrypted, a corresponding SA is identified using the source IP address, the destination IP address, and the SPI values in the IKEv2 header of the received packet. The key is retrieved, and a decryption process is performed. In IKEv2, because the source IP address and the destination IP address are fixed, different IP addresses are not allowed when the SA is retrieved.

On the other hand, in a terminal supporting MOBIKE that is a protocol with mobility and multihoming extension to the IKEv2 protocol, the SA is retrieved under an assumption that the source address arbitrarily changes when the received packet is decrypted. Furthermore, because the destination address can either be an address before movement or an address after movement, the SA is required to be retrieved under this assumption. N(NAT_DETECTION_SOURCE_IP) and N(NAT_DETECTION_DESTINATION_IP) are also ordinarily included in the encrypted data section. N(NAT_DETECTION_SOURCE_IP) and N(NAT_DETECTION_DESTINATION_IP) are both pieces of information used to confirm whether address change has occurred by NAT. Here, a description of these information elements is omitted.

As shown in FIG. 1, after the terminal A sends the address change request message 11 to the terminal B, the terminal A receives an address change request message (second address change request) 12 from the terminal B while waiting for a response message to arrive from the terminal B. The received address change request message 12 is a conventional MOBIKE message. The message includes IPhdr (IP_B_new→IP_A_old), HDR(msgID_B1), and SK[N(UPDATE_SA_ADDRESSES)]. Message content is similar to that of the address change request message 11. The address change request message 12 differs from the address change request message 11 in that the source address is the new address of the terminal B, namely IP_B_new, the destination address is the old address of the terminal A, namely IP_A_old, and the value of the message ID within the IKEv2 header is msgID_B1.

In the conventional technology, a following response message is sent in response to the address change request message 12 from the terminal B. The response message includes IPhdr(IP_A_old→IP_B_new), HDR(msgID_B1), and SK[ . . . ]. Ordinarily, N(NAT_DETECTION_SOURCE_IP) and N(NAT_DETECTION_DESTINATION_IP) are included within SK[ . . . ] of the response message. However, because N(NAT_DETECTION_SOURCE_IP) and N(NAT_DETECTION_DESTINATION_IP) are not directly related to the present invention, explanations thereof are omitted. As a result of the same value as that in the request message being set as the message ID within HDR of the response message, the terminal B can be informed that the message is a response message to the address change request message 12.

Here, in the present invention, the terminal A sends a next address change request message (third address change request) 13. The change request message 13 includes IPhdr(IP_A_new→IP_B_new), HDR(msgID_A2), SK[N(UPDATE_SA_ADDRESSES), REQUEST(msgID_A1), REPLY(msgID_B1)]. The address change request message 13 is a message to which a new message ID, msgID_A2, is assigned. When the terminal B receives the address change request message 13, the terminal B starts processing the address change request message 13 as a new message.

The terminal A newly adds information elements REQUEST(msgID_A1) and REPLY(msgID_B1) to the address change request message 13. REQUEST(msgID_A1) indicates that the message also functions as a re-sent message of the address change request message 11. REPLY(msgID_B1) indicates that the message also functions as the response message for the address change request message 12.

The terminal B that has received the address change request message 13 starts processing the address change request message 13 as a new message because the message ID is new. Then, the terminal B first discovers that the address change request message 13 includes the function as the response message for the address change request message 12 when decrypting the data within SK[ . . . ]. As a result of the terminal A sending the address change request message 13, sending of the response message and re-sending of the address change request message 11 can be omitted. Moreover, loss due to waiting time that occurs when the address request message 11 has not reached the terminal B, and needless sending and reception of numerous messages that occurs when the address request message 11 reaches the terminal B and the terminals mutually re-send the address change request messages can be avoided.

An operation performed by the terminal B when the address change request message 13 is received differs depending on whether the address change request message 11 from the terminal A has been received. First, when the address change request message 11 has not been received will be described. In this instance, the terminal B sends a response message 14 such as the following. The response message 14 includes IPhdr(IP_B_new→IP_A_new), HDR(msgID_A2), SK[ . . . ]. The response message 14 is the same as a conventional MOBIKE message. The message ID is set to msgID_A2, and the terminal A is immediately informed that the message is a response message to the address change request 13.

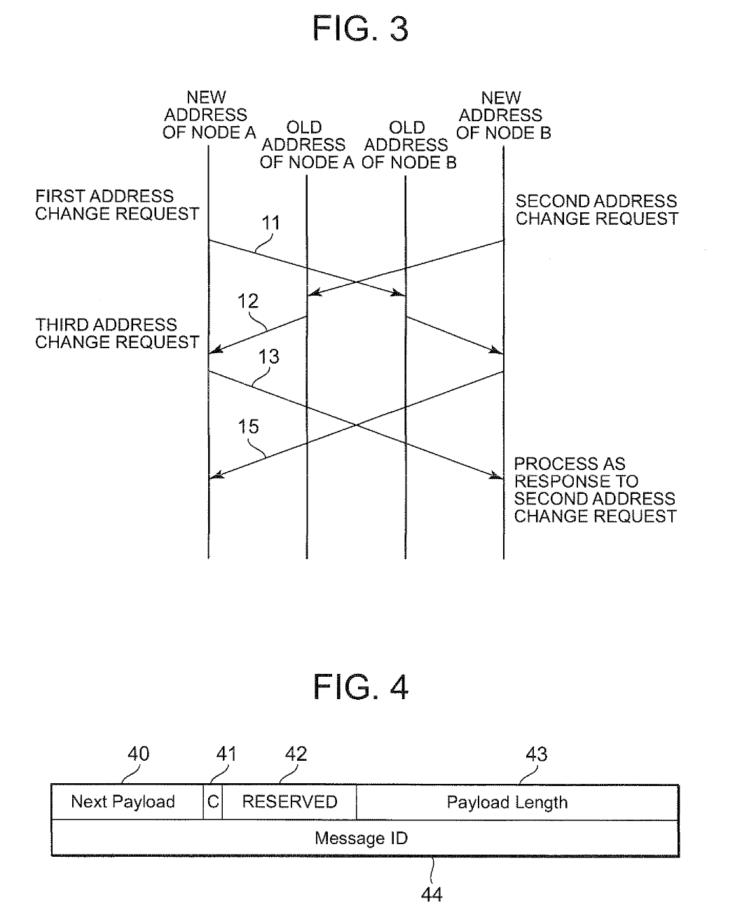

Next, when the terminal B has received the address change request message 11 will be described with reference to FIG. 3. As Like the terminal A, when the terminal B performs an operation of the terminal of the present invention, the terminal B sends a new address change request message 15 after receiving the address change request message 11 from the terminal A. The address change request message 15 in this instance is a message such as the following. The address change request message 15 includes IPhdr(IP_B_new→IP_A_new), HDR(msgID_B2), SK[N(UPDATE_SA_ADDRESSES), REQUEST(msgID_B1), REPLY(msgID_A1)].

The terminal A that has received the address change request message 15 starts processing the address change request message 15 as a new message because the message ID is a new value, msgID_B2. Then, from REQUEST(msgID_B1) within the message, the terminal A can confirm that the terminal A has already sent the address change request message 13 as a response. From REPLY(msgID_A1), the terminal A can also confirm that the initially sent address change request message 11 has reached the terminal B. When the address change request message 15 is received, the terminal A can know that the process for changing the addresses of both ends of the SA between the terminal A and the terminal B has been completed. The operation of the terminal B that has received the address change request message 13 is similar to the above-described operation.

Here, a data format of REQUEST(msgID) and REPLY(msgID) will be described with reference to FIG. 4. As shown in FIG. 4, areas of Next Payload 40, critical (C) 41, RESERVED 42, and Payload Length 43 are the same as ordinary information elements defined by IKEv2. A value indicating the type of the subsequent information element is set in Next Payload 40. A bit indicating whether the request receiving end can ignore the information element without performing processing when the information element is unknown is set in C 41. RESERVED 42 is a reserved area. A length of the payload is set in payload length 43.

When the present invention is widely applied, as the value set in the Next Payload 40, a value of Request Message ID for indicating REQUEST(msgID) and a value of Reply Message ID indicating REPLY(msgID) are required to be newly decided. A value of an actual Message ID 44 is set in an area following an ordinary header section (Next Payload 40, C 41, RESERVED 42, and Payload Length 43).

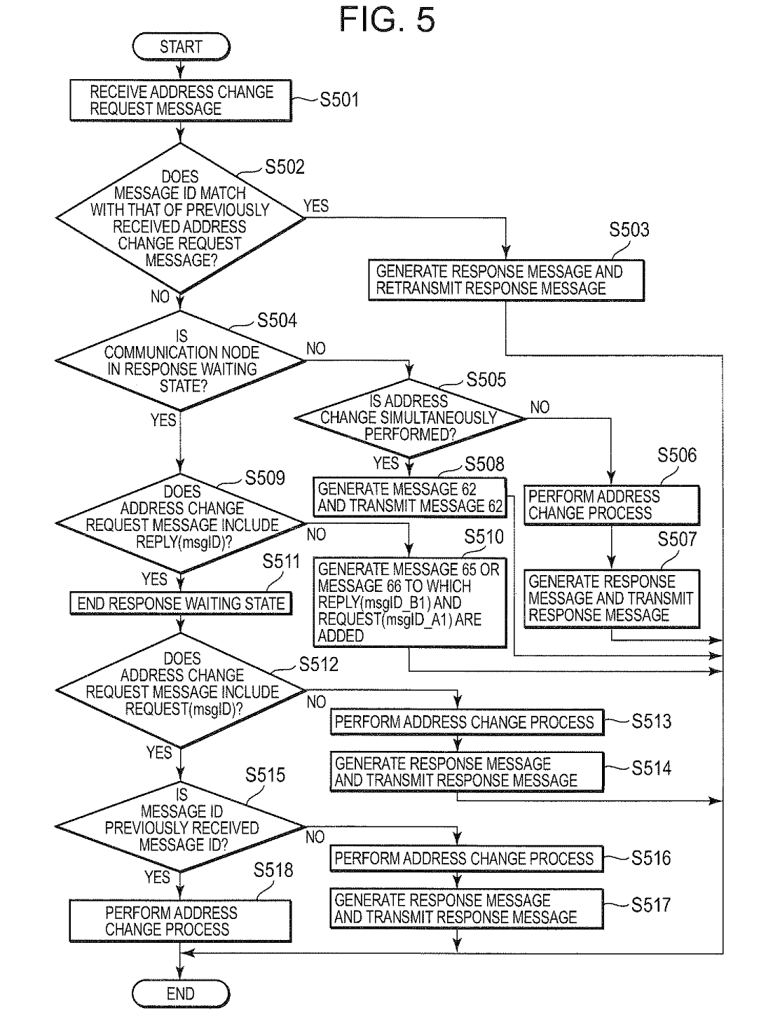

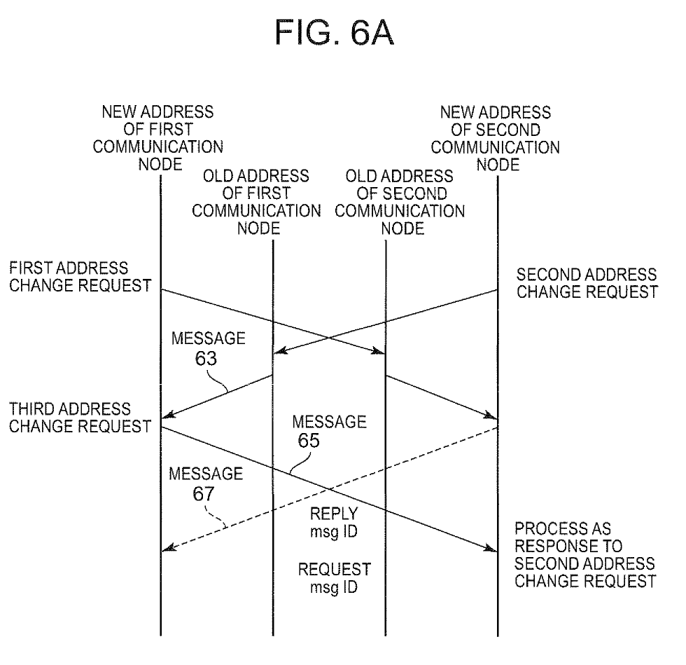

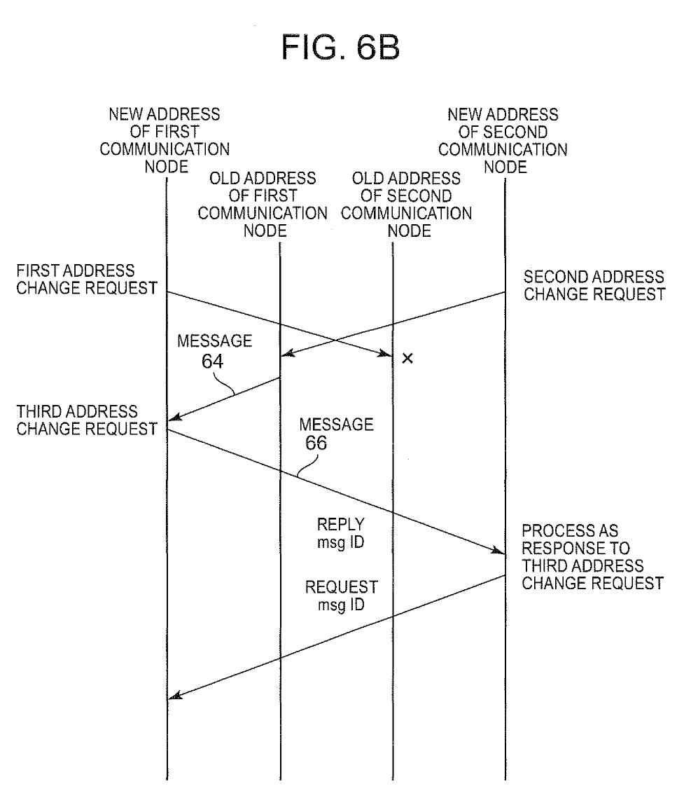

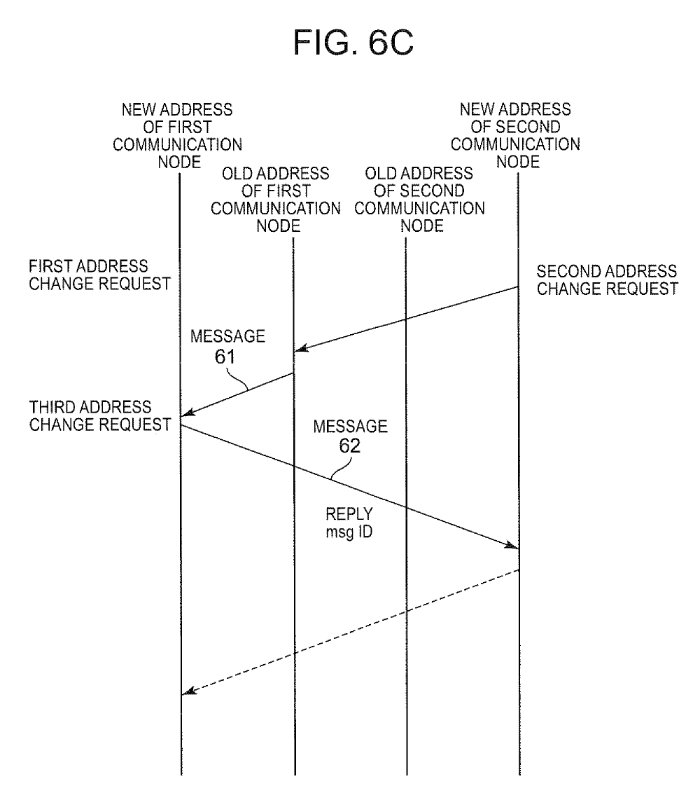

Next, a processing flow of a communication node when an address change request message is received will be described with reference to FIG. 5. Here, to explain the processing flow of the communication node, FIG. 6A to FIG. 6C are referenced to describe relevant message sequences. In a message sequence in FIG. 6A and a message sequence in FIG. 6B, the first communication node (terminal A) receives an address change request message from the second communication node (terminal B) immediately after sending an address change request message. The first communication node then sends the third address change request message to which REQUEST(msgID_A1) and REPLY(msgID_B1) are added.

The message sequence in FIG. 6A is that of when the first address change request message has reached the second communication node. The message sequence in FIG. 6B is that of when the first address change request message has not reached the second communication node. A message sequence in FIG. 6C is that of when the first communication node receives the second address change request message from the second communication node when the first communication node has not sent the first address change request message. REPLY(msgID_B1) is added to the third address change request message. An operation of this message sequence will be described in detail according to the second embodiment.

REPLY_NG(msgID_B1) according to the second embodiment described hereafter can be added to the third address change request message instead of REPLY(msgID_B1). The third address change request message may not include information related to the second address change request message.

Regarding FIG. 5, first, a communication node (such as the first communication node) receives an address change request message (S501). The communication node can judge whether the message is an address change request message by checking the initiator flag in the flag area of the IKEv2 header. In the IKEv2 specification, some types of address change request messages are defined. However, here, the message for changing addresses (UPDATE_SA_ADDRESSES) that is related to the present invention will be described.

First, the communication node checks whether the value of the message ID in the IKEv2 header matches one of message IDs of the address change request messages that have received previously (S502). The communication node also uses the source address to check the message ID because the message ID is decided uniquely by the source communication node. When the value of the message ID is the same as an already received value, the communication node knows that the address change request message has already been received. Therefore, the communication node can know the situation that a response to the partner communication node may not have reached, or that the address change request message may have been re-sent before arrival of the response. The communication node generates a response message and re-sends the response message (S503).

On the other hand, when the message ID is a new ID, the communication node checks whether the communication node itself has sent an address change request message and is in a response waiting state (S504). If the communication node is not in the response waiting state, it is state that the communication node receives a message 61. The communication node judges whether to simultaneously make an address change request (S505). When the change is not simultaneously performed, the communication node performs the process to change addresses in the SA by the address change request message in a conventional manner (S506). The communication node generates the response message and sends the response message (S507). When the communication node decides to simultaneously make the address change, the communication node generates a message 62 and sends the message 62 (S508). REPLY(msgID_B1) is included in the message 62.

Next, when the communication node sends the address change request message and is in the response waiting state, and the address change request message is received from the communication partner, the communication node checks whether REPLY(msgID) is included in the address change request message (S509). REPLY(msgID) not being included is equivalent to when a message 63 or a message 64 is received. The communication node generates a message 65 or a message 66 to which REPLY(msgID_B1) and REQUEST(msgID_A1) are added, and sends the generated message (S510).

REPLY(msgID) being included is equivalent to when the message 65 or the message 66 is received. The communication node ends the response waiting state regarding the address change request message having the message ID (S511). When the response does not arrive while the communication node is in the response waiting state, the communication node is required perform a process, such as re-sending the address change request message. Therefore, when the response is received, the communication node is required to be released from this state.

Next, the communication node checks whether REQUEST(msgID) is not included in the address change request message (S512). REQUEST(msgID) not being included is equivalent to when the message 62 is received. The communication node performs the SA address change request process in adherence to the address change request message (S513). The communication node generates a response message and sends the response message (S514). REQUEST(msgID) being included is equivalent to when the message 65, a message 67, or the message 66 is received. The communication node checks whether the message ID in the REQUEST is a previously received message ID (S515). The communication node also uses the source address of the message to check the message ID.

The message ID included in the REQUEST being new is equivalent to when the message 66 is received. The communication node performs the SA address change process in adherence to the address change request message (S516). The communication node generates the response message, and sends the response message (S517). The message ID included in the REQUEST having been previously received is equivalent to when the message 65 or the message 67 is received. The communication node performs the SA address change process (S518) and ends the process. An explanation of the processing flow when the address change request message is received is as described above.

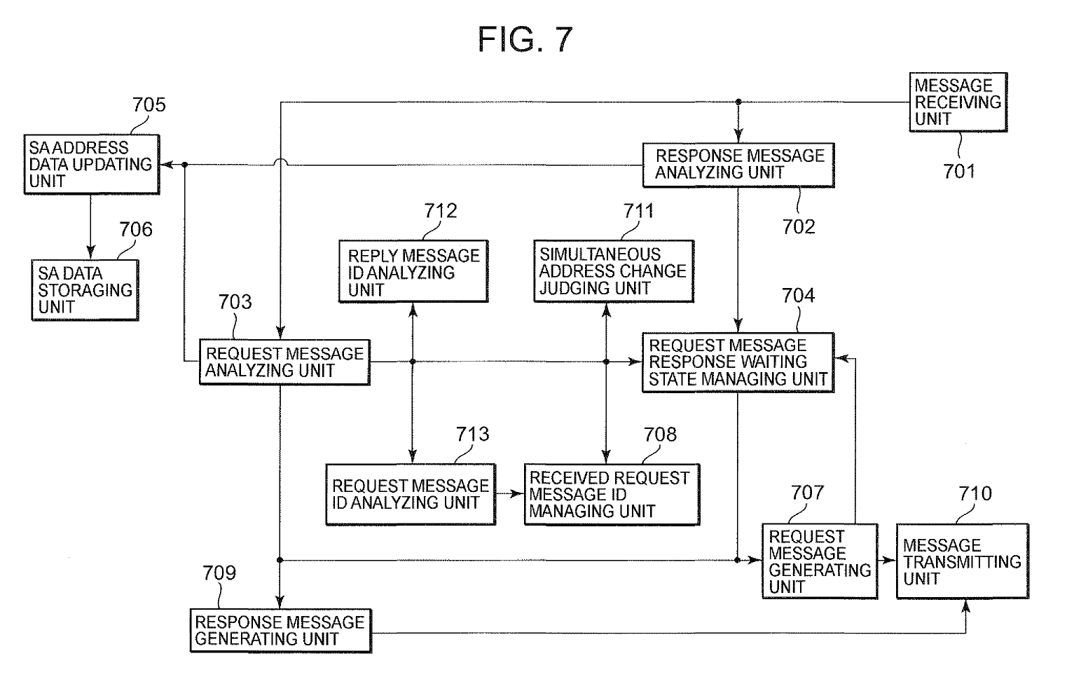

Next, an operation of the communication node when the response message and the address change request message are received will be described with reference to FIG. 7. FIG. 7 shows an example of a configuration of a communication node. When a message receiving unit 701 of the communication node receives the response message, the response message is sent to a response message analyzing unit 702. The response message analyzing unit 702 analyzes the response message and issues an order to end the response waiting state to a request message response waiting state managing unit 704, based on the analysis result. The response message analyzing unit 702 also makes the SA address data updating unit 705 to perform address change based on the analysis result.

The SA address data updating unit 705 updates address data in the SA data storaging unit 706 based on the order from the response message analyzing unit 702. The request message response waiting state managing unit 704 manages a timer for the response waiting state. The request message response waiting state managing unit 704 requests that the request message generating unit 707 re-send the address change request message when waiting time exceeds a predetermined constant value. The request message response waiting state managing unit 704 can end the waiting state when the number of re-sent messages exceed a predetermined constant value and stop further re-sending of messages.

When the message receiving unit 701 receives the address change request message, the address change request message is sent to a request message analyzing unit 703. The request message analyzing unit 703 makes a received request message ID managing unit 708 check whether the address change request message is a new message that has not been previously received or not. When the address change request message has a previously received message ID, the request message analyzing unit 703 makes a response message generating unit 709 create a response message. The response message generating unit 709 makes the message transmitting unit 710 send the created response message.

When the message ID of the received address change request message is a new value, the request message analyzing unit 703 confirms with the request message response waiting state managing unit 704 whether the communication node itself is in the response waiting state after sending of the address change request message. When the communication node is not in the waiting state, the request message analyzing unit 703 asks a simultaneous address change judging unit 711 whether to simultaneously change the address of the communication node itself with the address change request message from the communication partner. When the address change is not simultaneously performed, the request message analyzing unit 703 makes the SA address data updating unit 705 to update the address of the partner communication terminal in the SA.

When the address change is simultaneously performed, the request message analyzing unit 703 makes the request message generating unit 707 generate an address change request message including REPLY(message ID). The message ID set in REPLY( ) is the message ID of the received address change request message. The request message generating unit 707 makes the message transmitting unit 710 send the generated address change request message.

When the address change request message is received, the message ID is a new value, and the communication node itself sends an address change request message and is in the response waiting state, the request message analyzing unit 703 makes a REPLY message ID analyzing unit 712 confirm whether REPLY(message ID) is included in the received address change request message. When REPLY(message ID) is not included, the request message analyzing unit 703 makes the request message generating unit 707 generate a request message to which REPLY(message ID) and REQUEST(message ID) are added. The message ID set in REPLY( ) is the message ID of the received request message. The message ID set in REQUEST( ) is the message ID of the address change request message to which the communication node is waiting a response.

When the message ID of the received address change request message is a new value, the communication node itself has also sent an address change request message and is in the response waiting state, and REPLY(message ID) is included in the received address change request message, the request message analyzing unit 703 makes the request message response waiting state managing unit 704 end the response waiting state. The request message analyzing unit 703 also makes the REQUEST message ID analyzing unit 713 confirm whether REQUEST(message ID) is included in the received address change request message.

When REQUEST(message ID) is not included, the request message analyzing unit 703 makes the SA address data updating unit 705 update the address information of the SA, When REQUEST(message ID) is included, the REQUEST message ID analyzing unit 713 makes the received request message ID managing unit 708 check whether the same message ID is included in previously received address change request messages. When the message ID set in REQUEST( ) is the same as a previously received message ID, the request message analyzing unit 703 makes the SA address data updating unit 705 perform the address change. The address change request message receiving process is completed.

When the message ID set in REQUEST( ) is a new message ID that has not been previously received, the request message analyzing unit 703 makes the SA address data updating unit 705 change the address information and further makes the response message generating unit 709 generate the response message. The response message generating unit 709 makes the message transmitting unit 710 send the generated response message.

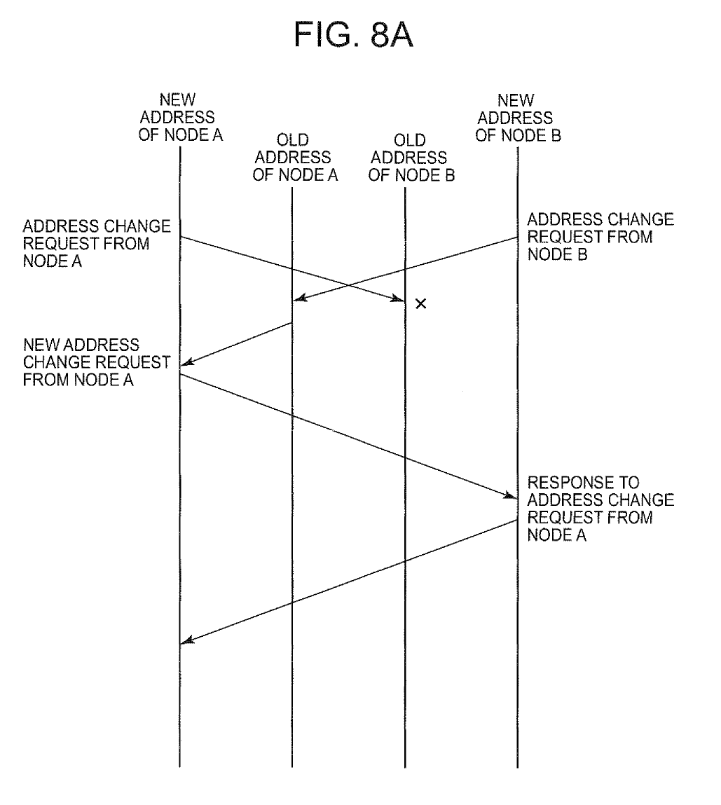

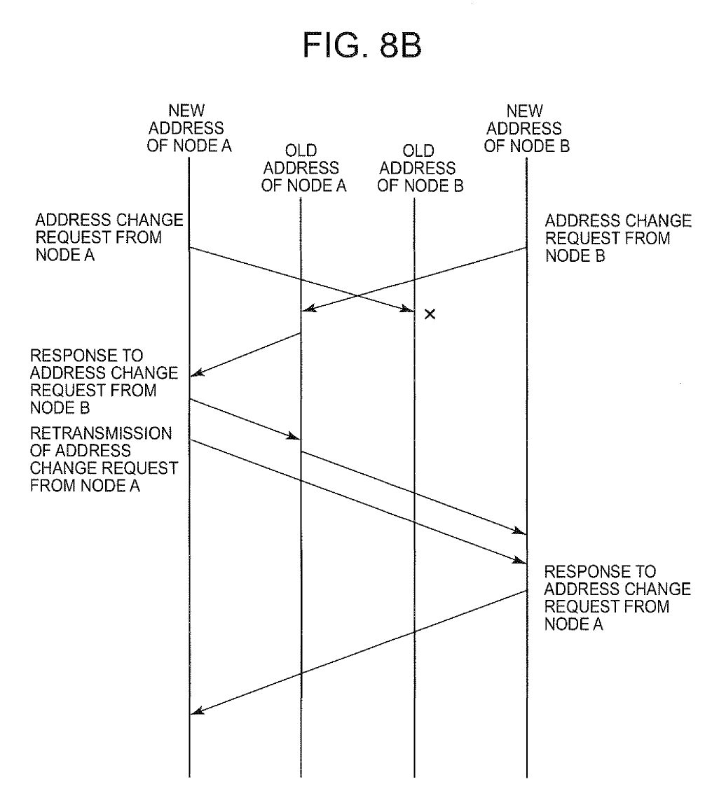

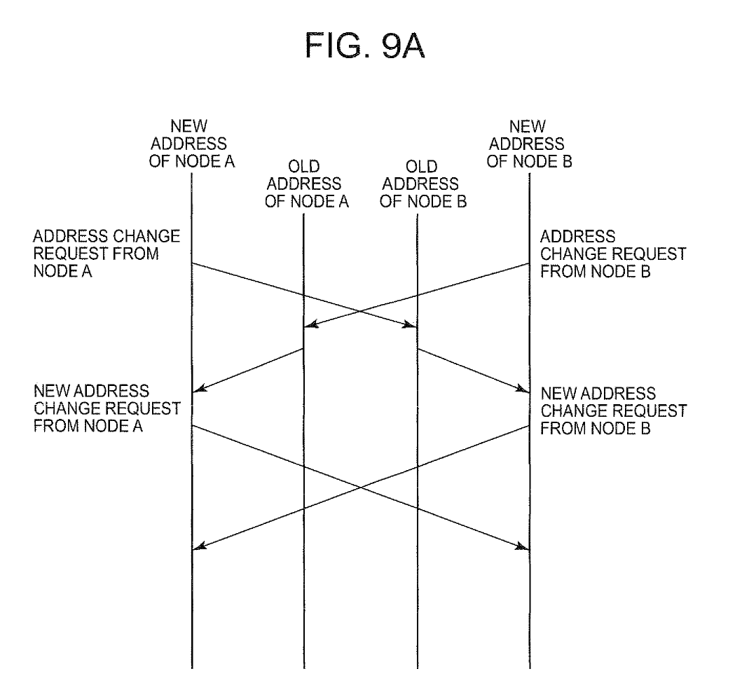

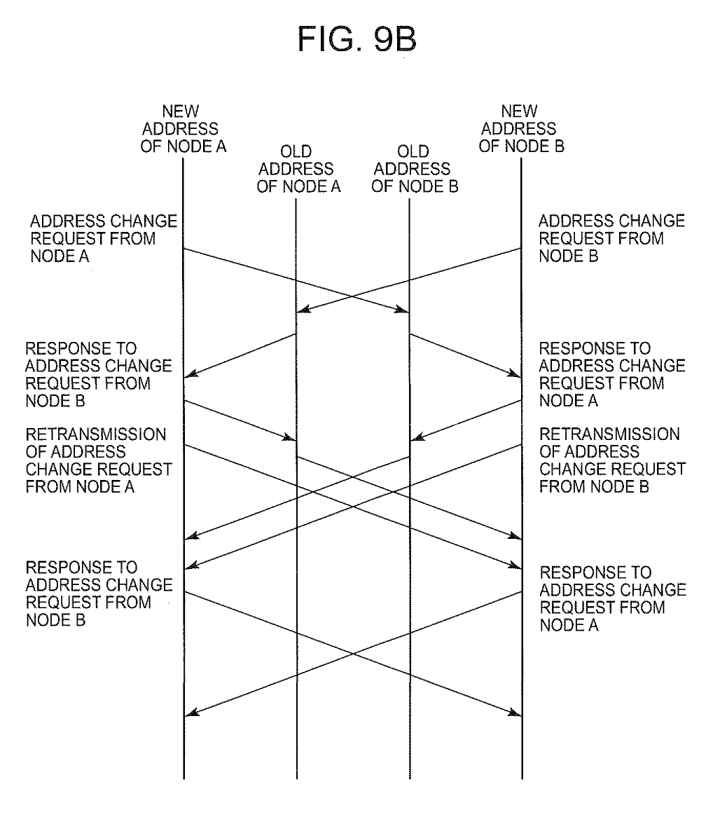

Next, effects of the present invention will be described. As shown in FIG. 8A, compared to the conventional method using MOBIKE protocol shown in FIG. 8B, the number of messages required for the terminals on both ends to change the addresses of the SA can be reduced, and the amount of time required to change the addresses can be shortened. Moreover, when the terminal B forwards a message addressed to the old address to the new address, in the conventional technology, the terminal B discovers that the destination of an already sent address change request message is an old address when the terminal B receives the address change request message from the communication partner, and cannot judge whether the already sent address change request message has reached the communication partner, as shown in FIG. 9B. Therefore, a situation in which the terminal B re-sends the address change request message without waiting for a response from the communication partner occurs more frequently. The same applies to the terminal on the communication partner end. The terminal may perform a similar operation.

A response message is returned for each re-sent request message. Therefore, in the conventional method, when a situation occurs in which the terminals on both ends simultaneously give notification of an address change, numerous messages are sent and received. Time is required for this state to end. On the other hand, when the method of the present invention is used, as shown in FIG. 9A, the number of messages required to actualize the address changes of the terminals on both ends of the SA can be reduced. The amount of time required to perform the address changes can be shortened.

In the method of the present invention, the request for changes to be made in the address information of the terminals on both ends of the SA is made in a single address change request message. Therefore, an advantageous effect can be achieved in that the processes for changing data in the address information of the SA can more easily be combined into a single process. In the conventional method, a single address change request message includes a request to change one address. Therefore, two address change request messages are required to change the address information of the SA for each end. Ordinarily, the information of the SA is managed as a database. Address information is handled as a change in the information in the database.

In the method of the present invention, a process for changing the information, conventionally requiring the database to be accessed twice, can be performed by the database being accessed once. In the conventional method, the processes for reflecting the address changes of the SA in the database can be combined. However, it is difficult to predict reception of the other address change request immediately after one address is changed. When an anticipated and awaited request is not received, a problem occurs in that the reflection of the SA information in the database is delayed. When the present invention is used, a single message can indicate that both addresses are required to be changed. Therefore, the number of accesses to the database to change the addresses of the SA can be easily reduced to a single access operation.

### Second Embodiment

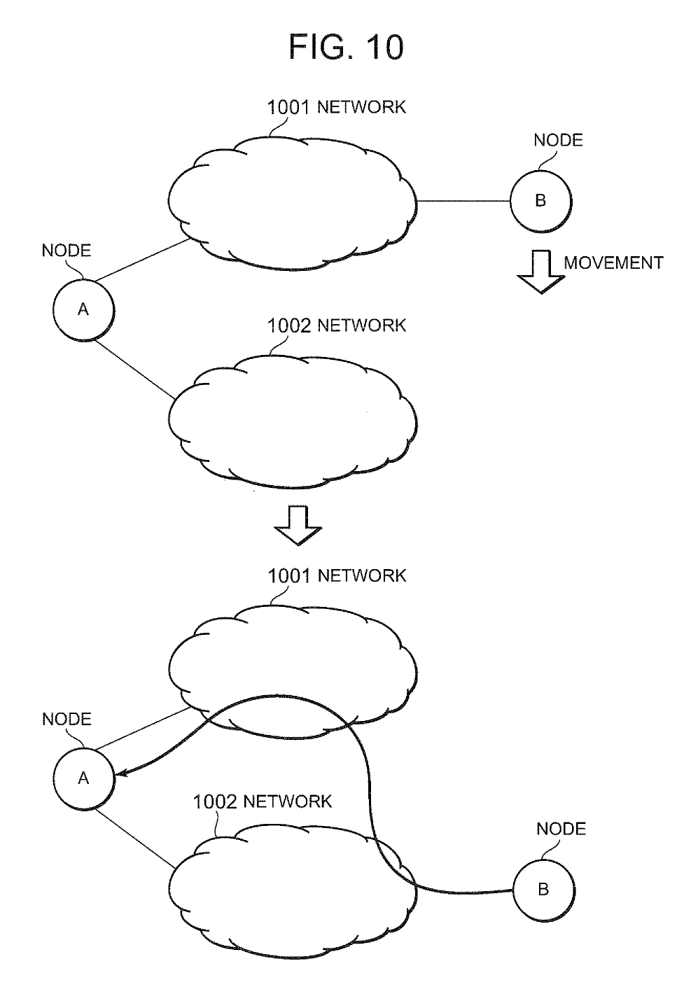

The second embodiment will be described. According to the second embodiment, a multilink terminal (device) sends a new address change request message using an address change request message from a communication partner as a trigger. The second embodiment will be described in detail below, with reference to FIG. 10.

A terminal A is connected to both network 1001 (NetA) and network 1002 (NetB). Addresses are respectively IP_A_old(NetA) and IP_A_new(NetB). A terminal B moves from the network 1001 to the network 1002. At this time, an address of the terminal B changes from IP_B_old to IP_B_new. The terminal B notifies the terminal A of the change in the address. The address change request message is sent to IP_A_old that is the address of the terminal A. As a result of the address change request message being sent, the address request change message reaches the terminal A from the network 1002 via the network 1001.

The terminal A that has received the address change request message can know, for example, from a source address of the address change request message whether to also change the address on the terminal A end to IP_A_new (NetB). In terms of an instance such as that according to the first embodiment, this is the same as a situation in which the terminal A plans to send the address change request message but receives the address change request message from the terminal B before the address change request message can be sent.

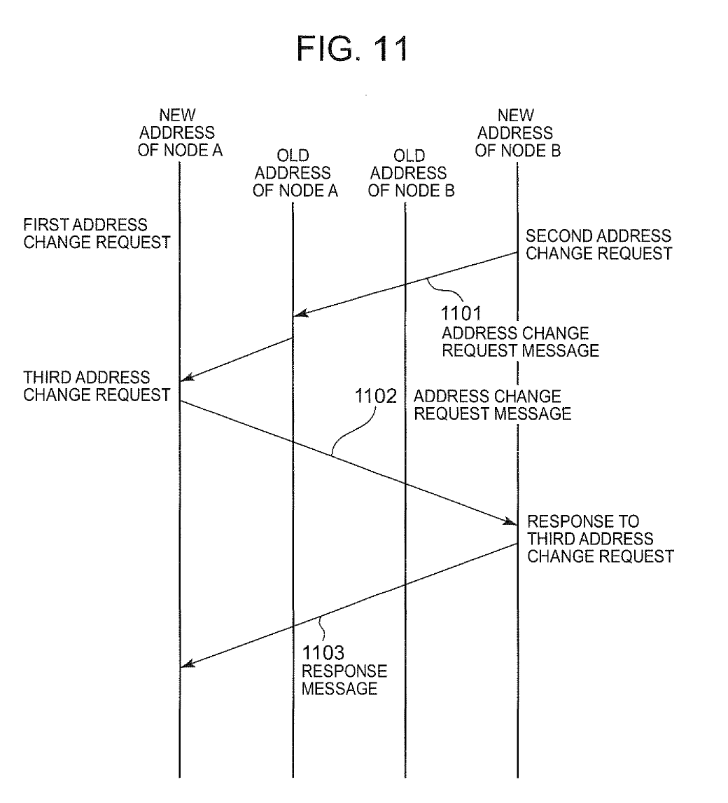

As shown in FIG. 11, an address change request message 1101 sent from the terminal B is a conventional MOBIKE message, and includes IPhdr(IP_B_new→IP_A_old), HDR(msgID_B1), and SK[N(UPDATE_SA_ADDRESSES)]. On the other hand, an address change request message 1102 sent from the terminal A includes IPhdr(IP_A_new→IP_B_new), HDR(msgID_A2), and SK[N(UPDATE_SA_ADDRESSES), REPLY(msgID_B1)]. A response message 1103 subsequently sent from the terminal B includes IPhdr(IP_B_new→IP_A_new), HDR(msgID_A2), and SK[ . . . ].

Here, the address change request message 1102 differs from a conventional message in that REPLY(msgID_B1) is included. As a result of a REPLY information element being included, the terminal B can end a response waiting state entered after sending the address change request message 1101. The second embodiment differs from the first embodiment in that REQUEST(msgID_A1) is not included. The terminal B that has received the address change request message 1102 has not previously received an address change request message having msgID_A1 as the message ID. Therefore, in a manner similar to that according to the first embodiment, the terminal B sends the response message 1103 in response to the address change request message 1102.

A method can be considered in which REPLY(msgID_B1) is intentionally not included in the address change request message 1102. In other words, the address change request message in this instance includes IPhdr(IP_A_new→IP_B_new), HDR(msgID_A2), and SK[N(UPDATE_SA_ADDRESSES)]. In this instance, although the terminal A has received the address change request message 1101 from the terminal B, the terminal A ignores the address change message 1101 and sends the new address change request message 1102 without sending the response message.

To correctly interpret the address change request message, the terminal B is required to read from the IP header that the address change request in the address change request message 1102 is for changing the addresses of both terminal A and terminal B (IP_A_old to IP_A_new, and IP_B_old to IP_B_new), confirm that the change includes the content of the already sent address change request message 1101, end the waiting state for the response to the address change request message 1101, and stop re-sending the address change request message 1101.

Instead of REPLY(msgID_B1) being included in the address change request message 1102, a method can also be considered in which REPLY_NG(msg_B1) is newly added. The address change request message 1102 in this instance includes IPhdr(IP_A_new→IP_B_new), HDR(msgID_A2), and SK[N(UPDATE_SA_ADDRESSES), REPLY_NG(msgID_B1)]. When this address change request message is sent, as a result of the terminal A explicitly rejecting the address change request message 1101, the terminal B cancels the state requested by the address change request message 1101 and executes the content in the address change request message 1102 from the terminal A.

As a result of the address change request message 1102, the terminal B ends the response waiting state entered after sending the address change request message 1101. As a result the address change request message 1101 being rejected, the terminal B cancels the process for changing the address information of the SA. Then, in adherence to the address change request message 1102, the address information of both terminal A and terminal B of the SA are simultaneously changed.

An advantageous effect of the present invention is that the address information of the terminals on both ends of the SA can be more easily simultaneously changed. When the conventional MOBIKE protocol is used, the address change is performed one end at a time by a single round-trip of the request message and the response message. Therefore, the address information of the SA is changed one end at a time. However in the present invention, the address change request message is a message requesting change in the address information of both ends of the SA. Therefore, the addresses of both ends of the SA can be more easily changed. As a result of REPLY_NG(msgID_B1) being included in the address change request message and the analyzing unit being provided, the SA address changing process can be quickly performed.

### Third Embodiment

In 3^{rd} Generation Partnership Project (3GPP) that is a standardization group for third generation mobile phones, studies are being held regarding System Architecture Evolution (SAE), which is a next generation network architecture (refer to TR 23.882 “3GPP system architecture evolution (SAE): Report on technical options and conclusions”).

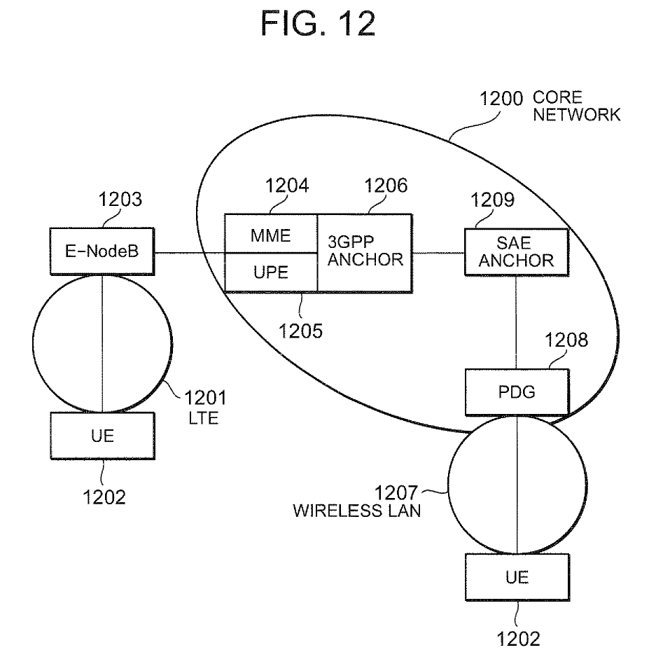

A 3GPP network can be largely divided into two. In other words, the 3GPP network is divided into two networks, a core network (CN) 1200, which is a core network such as that shown in FIG. 12, and a radio access network (RAN). The radio access network is referred to as a long term evolution (LVE) 1201. A mobile phone terminal is referred to as a user equipment (UE) 1202. The UE 1202 is connected to an E-NodeB (base station) 1203 via the radio access network (LTE) 1201, and is further connected to a mobility management entity (MME) 1204, a user plane equipment (UPE) 1205, and a 3GPP anchor (Anchor) 1206, which are nodes in the core network 1200.

A path by which the UE 1202 connects to the 3GPP network uses a radio access method that standardizes 3GPP and is referred to as a 3GPP access. On the other hand, a method of connecting to the 3GPP network by an access method other than 3GPP, such as wireless LAN (for example, IEEE 802.11b/g/a) 1207 is referred to as a Non-3GPP access. When the Non-3GPP access is used, a Packet Data Gateway (PDG) 1208 serves as a gateway and connects the UE 1202 to the 3GPP network. The SAE anchor (Anchor) 1209 is a device used to actualize a handover when the 3GPP access is used and when the Non-3GPP address is used. In the study of the network architecture of the 3GPP SAE, a proposal can be considered in which MOBIKE protocol is used between the PDG and the UE when wireless LAN is changed.

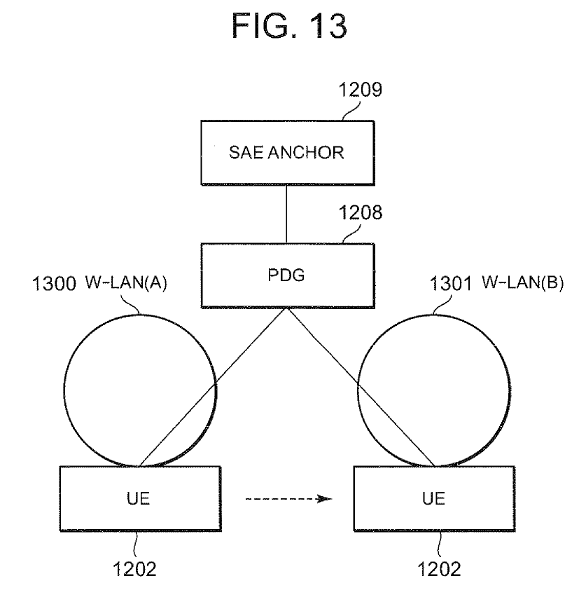

Here, expected operations of the PDG and the UE will be explained with reference to FIG. 13. The UE 1202 moves from a wireless LAN A (W-LAN(A)) 1300 to a wireless LAN B (W-LAN(B)) 1301. The UE 1202 connects to a new network and changes its address. The UE 1202 notifies the PDG 1208 of the new address using MOBIKE protocol and continues using the security association (SA) used when the UE 1202 was connected to the W-LAN(A) 1300 when connecting to the W-LAN(B) 1301. The use of MOBIKE protocol between the PDG and the UE during movement between wireless LANs in the network architecture of the 3GPP SAE currently being studied is as described above.

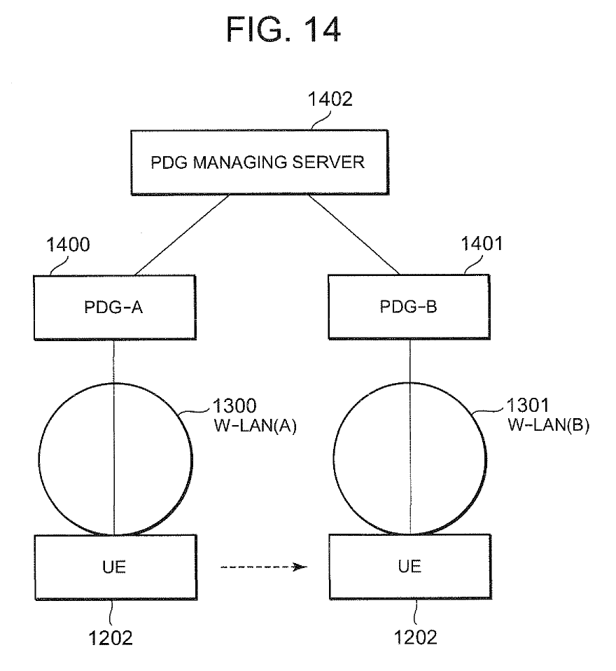

However, in the conventional technology, the PDG cannot be efficiently changed in accompaniment with the movement of the UE. For example, as shown in FIG. 14, under a circumstance in which a PDG-A 1400 is optimal as a packet forwarding path when the UE 1202 is connected to the W-LAN(A) 1300, and a PDG-B 1401 is optimal as the packet forwarding path when the UE 1202 is connected to the W-LAN(B) 1301, the PDG cannot be efficiently changed. Hereafter, as a device that manages changing of the PDG, a device connected to the PDG is referred to as a PDG managing server 1402. The SAE anchor can be provided with a PDG managing server function, or the network architecture can be configured with the PDG managing server as a separate device.

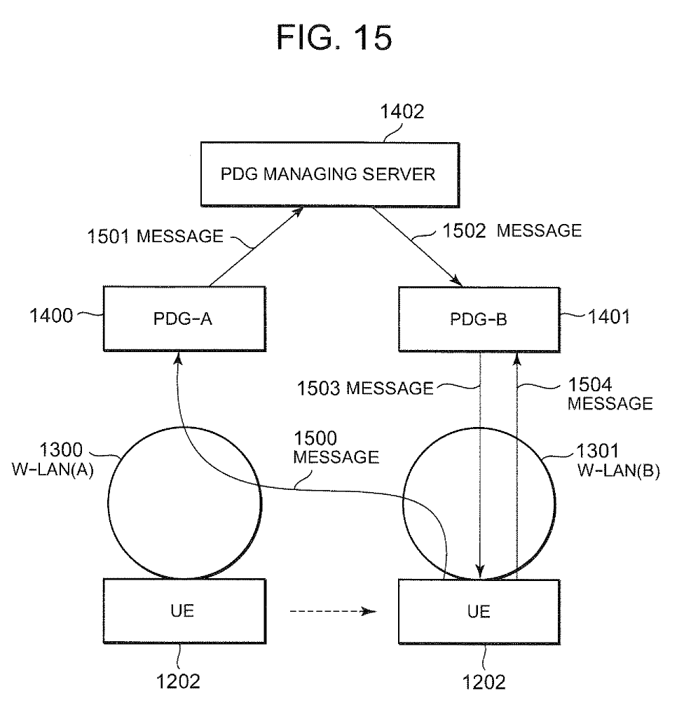

When the method of the present invention is used, the network side can change connection to an optimal PDG in accompaniment with the change in the address when the UE changes the network to which the UE is connected. Here, a flow of messages will be described with reference to FIG. 15. The UE 1202 moves from the W-LAN(A) 1300 to the W-LAN(B) 1301 and changes its address. The UE 1202 notifies the original PDG-A 1400 of this change using a message 1500. The message 1500 is an address change request message defined in the MOBIKE protocol.

The PDG-A 1400 notifies a node managing the PDG that the address change request has been received using a message 1501. Here, the notification destination is the PDG managing server 1402. The PDG managing server 1402 judges that changing the PDG is preferable, and sends a message 1502 to the PDG-B 1401. A method can be considered in which, as information on which the judgment is based, a PDG that shortens a packet path from the new address of the UE 1202 is selected. The PDG can also be selected by load balance being taken into consideration based on a state of load on the PDG. The PDG-B 1401 sends a message 1503 of the present invention to the UE 1202. The UE 1202 sends a response message 1504 to the PDG-B 1401.

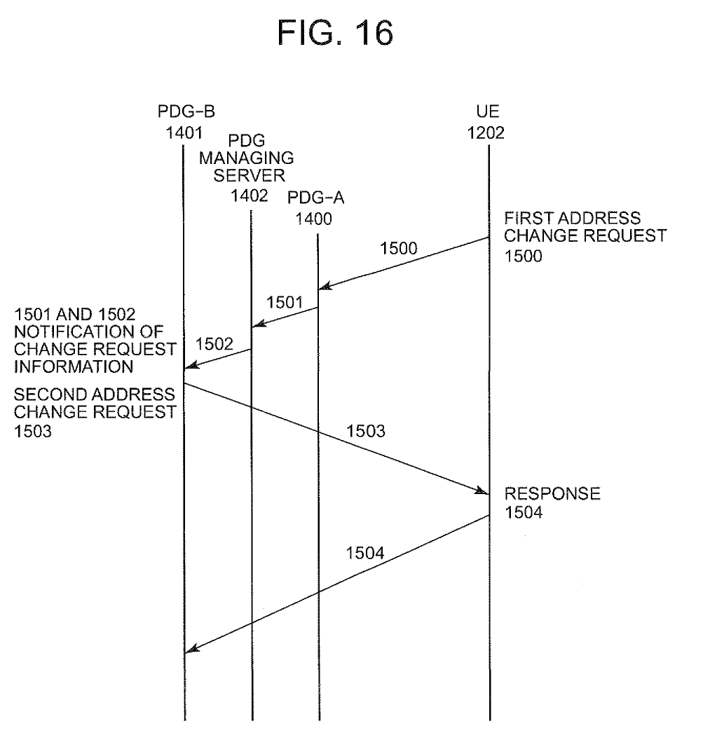

Next, each message will be described with reference to FIG. 16. The message 1500 is the first address change request message (a conventional MOBIKE message). A specific configuration is IPhdr(UE new address→PDG-A), HDR(msgID_U1), and SK[N(UPDATE_SA_ADDRESSES)]. The message 1503 is the second address change request message. The message 1503 includes the REPLY information element of the present invention, and indicates a response to the message 1500 by msgID_U1. A specific configuration is IPhdr(PDG-B→UE new address), HDR(msgID_B1), and SK[N(UPDATE_SA_ADDRESSES), REPLY(msgID_U1)]. The message 1504 is a response message (similar to the conventional MOBIKE message). A specific configuration is IPhdr(UE new address→PDG-B), HDR(msgID_B1), and SK[ . . . ].

Information included in message 1500 is included in the message 1501 and the message 1502 giving notification of the information regarding the address change request. The PDG managing server 1402 judges whether to change the PDG or not, the judgement is based on the information included in the message 1501. The PDG-B 1401 sends the message 1503 based on the information included in the message 1502. When the PDG-A 1400 can select the PDG-B 1401 that is the change destination, the PDG-A 1400 can send the message 1502 directly to the PDG-B 1401. The change in the address can also accompany link switching when the UE is a terminal that is capable of multilinking, in addition to the movement.

In the example described above, when the network side receives the address change request from the UE and simultaneously changes the address of the PDG in accompaniment is described. As another example, when the network side sends an address change request to the UE can be considered. For example, when connected UE are dispersed to even the load balance of the PDG can be considered. Changes caused by maintenance of the PDG, changes in the PDG in accompaniment with a dynamically changing path, and the like can also be considered. In this way, when the network side sends the address change request message, defined in the MOBIKE protocol, to the UE, in a manner similar to that described in the present invention, an instance may occur in which the UE and the PDG simultaneously send address change requests to the other. In a following example, when the address change request from the UE reaches the PDG-A, but the address change request from the PDG-B is sent to the old address of the UE and does not reach the UE will be described.

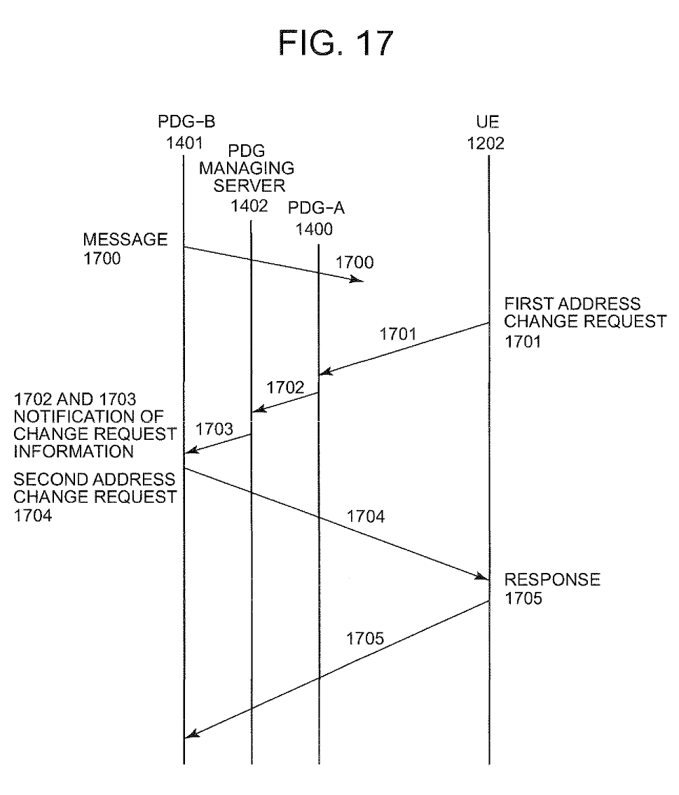

As shown in FIG. 17, the PDG-B 1401 sends a message 1700 to the UE 1202 to notify address change of the PDG. However, the UE 1202 cannot receive the message 1700 because the UE 1202 has already moved. At this time, in a message 1704, the message ID of the message 1700 is included as a REQUEST information element. Other messages are the same as the examples in FIG. 16.

Next, contents of each message will be briefly described. The message 1700 is a conventional MOBIKE message. A specific configuration is IPhdr(PDG-B→UE old address), HDR(msgID_B1), and SK[N(UPDATE_SA_ADDRESSES)]. The message 1701 is the first address change request message (conventional MOBIKE message). A specific configuration is IPhdr(UE new address→PDG-A), HDR(msgID_U1), and SK[N(UPDATE_SA_ADDRESSES)]. The message 1704 is the second address change request message. A specific configuration is IPhdr(PDG-B→UE new address), HDR(msgID_B2), and SK[N(UPDATE_SA_ADDRESSES), REQUEST(msgID_B1), REPLY(msgID_U1)]. The message 1705 is a response message, and is specifically IPhdr(UE new address→PDG-B), HDR(msgID_B2), and SK[ . . . ].

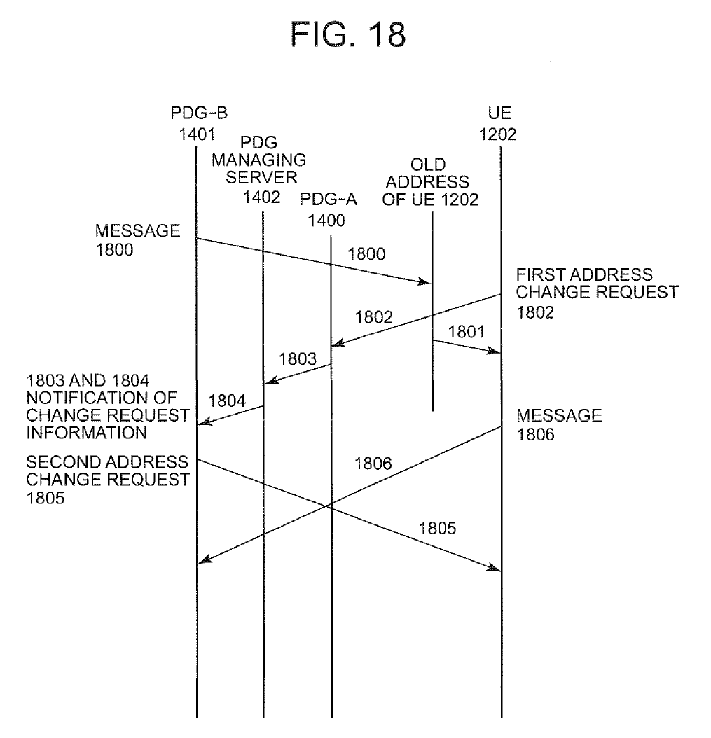

As a next example, when the UE can receive a message addressed to the old address through forwarding or the like will be described with reference to FIG. 18. The PDG-B 1401 sends an address change request message 1800, defined in the MOBIKE protocol, to the old address of the UE 1202. The message is then forwarded to the new address as message 1801. The PDG-B 1401 receives a message 1804 and sends a message 1805 in a manner similar to the above-described example. The message 1805 includes both the REQUEST information element and the REPLY information element.

The UE 1202 receives the message 1801 and sends a message 1806. The message 1806 includes both the REQUEST information element and the REPLY information element. The PDG-B 1401 that has received the message 1806 and the UE 1202 that has received the message 1805 are not required to send a response message. This point differs from the above-described example. A reason for which the UE 1202 that has received the message 1805 is not required to send the response message will be briefly described.

A source address of the message 1805 is the PDG-B 1401, and is changed from the PDG-A 1400 to a new address. Moreover, because the REQUEST information element in the message includes msgID_B1, it is clear that the request from the PDG-B 1401 is similar in content to the message 1800 and the UE 1202 has already returned a response by message 1806. In other words, it is clear that both have agreed to the change in address from the PDG-A 1400 to the PDG-b 1401. A destination address is the new address of the UE 1202. Moreover, the REPLY information element is included within the message as is the msgID_U1 of the already sent address change request message 1800. Therefore, it is clear that the content of the address change request has been communicated and both agreed that the address of the UE 1202 has newly changed.

Because the received message includes the new information element of the present invention, the UE 1202 knows that the PDG-B 1401 understands that the message 1806 sent to the PDG-B 1401 is a response to the message 1800. Therefore, the UE 1202 can judge that the PDG-B 1401 knows the following two things. First, the PDG-B 1401 knows that the address of the UE 1202 has been changed. Second, the PDG-B 1401 knows that the UE 1202 has acknowledged the change in address from the PDG-A 1400 to the PDG-B 1401. Therefore, the UE 1202 is not required to send the response message to the message 1805. The e PDG-B 1401 is not required to send the response message to the message 1806 for similar reasons.

Next, contents of each message are indicated. The message 1800 is a conventional MOBIKE message. A specific configuration is IPhdr(PDG-B→UE old address), HDR(msgID_B1), and SK[N(UPDATE_SA_ADDRESSES)]. The message 1802 is the first address change request message (conventional MOBIKE message). A specific configuration is IPhdr(UE new address→PDG-A), HDR(msgID_U1), and SK[N(UPDATE_SA_ADDRESSES)]. The message 1805 is the second address change request message. A specific configuration is IPhdr(PDG-B→UE new address), HDR(msgID_B2), and SK[N(UPDATE_SA_ADDRESSES), REQUEST(msgID_B1), REPLY(msgID_U1)].

A specific configuration of the message 1806 IPhdr(UE new address→PDG-B), HDR(msgID_U2), and SK[N(UPDATE_SA_ADDRESSES), REQUEST(msgID_U1), REPLY(msgID_B1)]. Here, when the PDG is switched is described. However, a similar process can be performed when the UE is switched. For example, the UE is switched from a terminal UE-A (not shown) to a terminal UE-B (not shown). The terminal may be switched when, for example, a function provided by the terminal UE-B but not provided by the terminal UE-A is used. Moreover, the terminal may be switched to a new terminal when a function provided by the terminal UE-A cannot be used. Furthermore, the terminal may be switched to the terminal UE-B because the terminal UE-A is required to be connected to a charger.

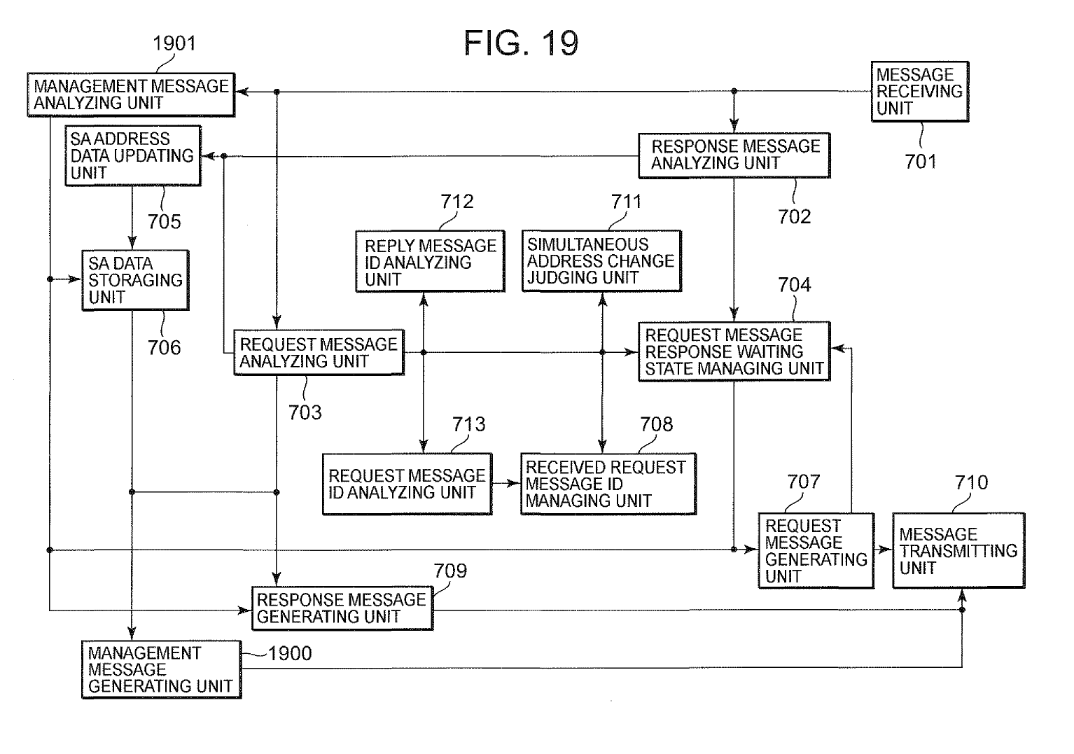

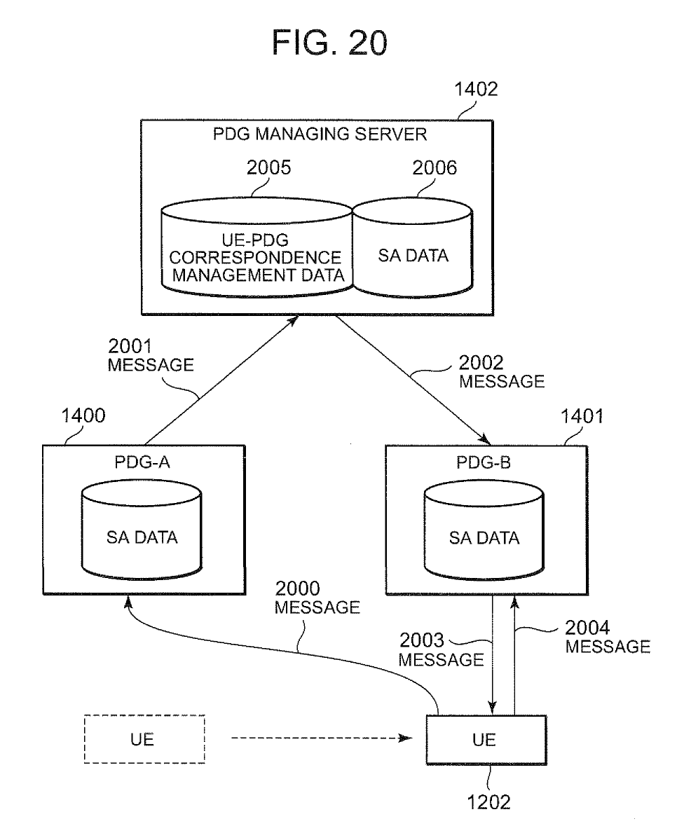

Next, a configuration of the PDG will be described with reference to FIG. 19. In the configuration of the PDG, a management message generating unit and a management message analyzing unit are added to the configuration of the communication node in FIG. 7. Before the configuration of the PDG is described, a relationship between the PDG managing server and the PDG will be described with reference to FIG. 20.

As shown in FIG. 20, the PDG managing server 1402 manages UE-PDG correspondence management data 2005 and SA data 2006. The SA data 2006 managed by the PDG managing server 1402 can include some pieces of data of the UE-PDG correspondence management data 2005. Based on the UE-PDG correspondence management data 2005, the PDG managing server 1402 switches the corresponding PDG in accompaniment with the movement of the UE 1202 and changes the PDG corresponding to the UE 1202 to disperse load of the PDG.

The SA data 2006 is data provided for each set of UE-PDG. Ordinarily, only the PDG is required to hold the SA data 2006. However, the SA data 2006 is held in the PDG managing server 1402 in advance to reduce the effort of obtaining the SA data from the original PDG and sending the SA data to the new PDG when the PDG is changed. Each PDG manages the data of the SA with the UE 1202. SA data is information on the IKE SA and the IPsec SA. When the SA data is updated, the PDG notifies the PDG managing server 1402 of the changes.

Here, when the UE sends an address change request to the PDG as a result of movement and the like will be described with reference to FIG. 19, which shows a block diagram of the PDG. Here, operations performed between the FOG and the FOG managing server will mainly be described. Other operations are similar to those described with reference to FIG. 7. The PDG-A 1400 receives a request message 2000 from the UE 1202. The PDG-A 1400 generates a message 2001 using a management message generating unit 1900 and sends the message 2001 to give notification to the PDG managing server 1402. The message 2001 includes the new address of the UR 1202 and the message ID of the request message.

The PDG managing server 1402 selects a corresponding PDG, taking into consideration the new address of the UE 1202, the position of the PDG, a load state, and the like. When the PDG-A 1400 is selected, the PDG managing server 1402 makes the PDG-A 1400 respond. At this time, the PDG-A 1400 analyzes the message using a management message analyzing unit 1901. The PDG-A 1400 then generates a response message using the response message generating unit 709 and sends the response message. When the PDG-B 1401 is selected, the PDG managing server 1402 makes the PDG-B 1401 send a request message.

Simultaneously with the order from the PDG managing server 1402 to send the request message, the PDG-B 1401 receives the SA information, the address of the UE 1202, and the message ID of the request message sent by the UE 1202. The management message analyzing unit 1901 loads the SA information into the SA data storaging unit 706. The request message generating unit 707 generates a request message 2003, and the request message 2003 is sent. The request message 2003 includes the message ID of the request message 2000 sent by the UE 1202.

The UE 1202 receives the request message 2003 and discovers that the address of the PDG is changed with the address change of the UE 1202. The UE 1202 sends a response message 2004. The PDG-B 1401 has received the response message 2004, and updates the data in the SA data storaging unit 706 using the SA address data updating unit 705. The PDG-B 1401 then creates a message using the management message generating unit 1900 and sends the message to notify the PDG managing server 1402 of update content.

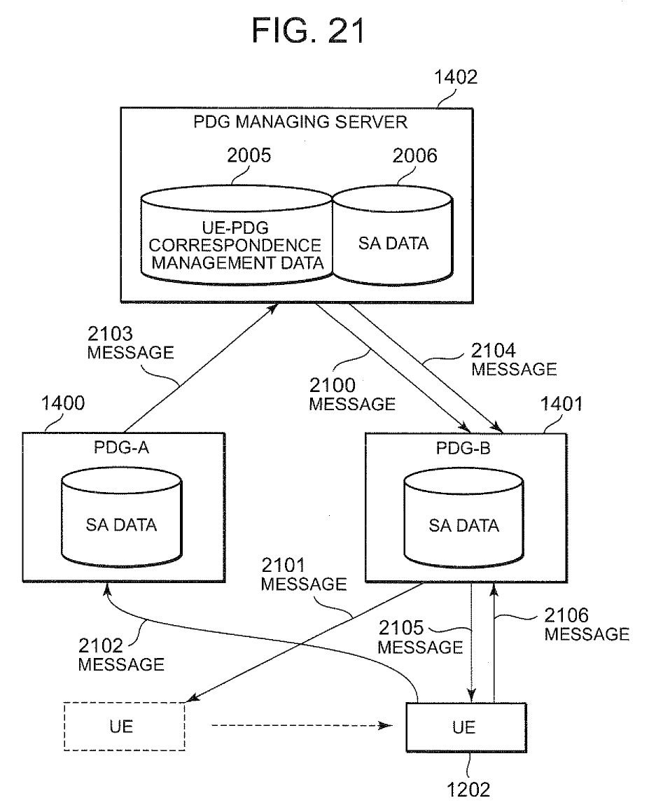

Next, when the PDG managing server starts to change the PDG before the UE moves will be described with reference to FIG. 21. The PDG managing server 1402 sends a message 2100 to the PDG-B 1401 to give notification to the UE 1202. The message 2100 includes SA data. The PDG-B 1401 sends an address change request message 2101 to the address of the UE 1202. When the message 2101 reaches the UE 1202, the UE 1202 returns a response message to the PDG-B 1401, and the PDG change is completed.

When the UE 1202 moves while the PDG-B 1401 is sending the message 2101, and the UE 1202 also sends an address change request message 2102 to the PDG-A 1400, the PDG-A 1400 sends a message 2103 to notify the PDG managing sever 1402 that an address change request has been received from the UE 1202. From the message 2103, the PDG managing server 1402 discovers that the UE 1202 side has also performed an address change during processing of the address change request on the PDG side. The PDG managing server 1402 sends a message 2104 to the PDG-B 1401. The message 2104 includes information on the message ID of the address change request message 2102 from the UE 1202. Because the SA information has already been sent in the message 2100, the SA information is not required to be sent at this time.

The PDG-B 1401 receives the message 2104 and sends an address change request message 2105 to the new address of the UE 1202. The message 2105 includes Request information indicating that the message 2105 is a re-sending of the message 2101 and Reply information indicating that the message 2105 is in response to the message 2102. The UE 1202 receives the message 2105 and sends a response message 2106. If the UE 1202 has received the message 2101 sent to the address before movement by forwarding or the like, and has yet to receive the message 2105, the message 2106 is an address change request message from the UE 1202.

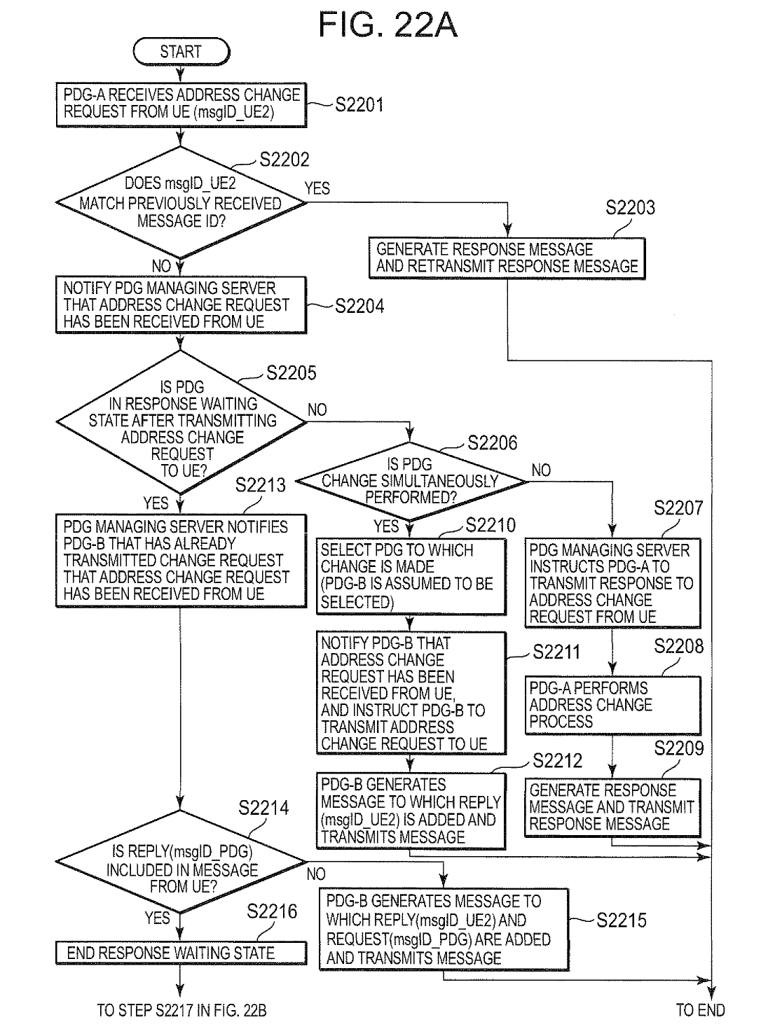

Next, an operational flow of the PDG, described above, will be described in detail with reference to FIG. 22A and FIG. 22B. First, a communication node PDG-A receives an address change request message sent from a communication partner node (UE) (S2201). Next, the communication node PDG-A checks whether a value of the message ID (msgID_UE2) in the IKEv2 header matches a message ID of a previously received address change request message (S2202). A source address is also used to check the message ID because the message ID is decided by the communication partner node (UE) uniquely. When the message ID is the same as a previously received value (YES at Step S2202), the communication node PDG-A knows that the address change request message is a message that has already been received. Therefore, the response may have not reached the communication partner node (UE) which address is the source address of the address change request, or the address change request message may have been re-sent before arrival of the response. Therefore, the communication node PDG-A creates a response message and re-sends the response message (S2203).

On the other hand, when the message ID does not match previously received message ID and is a new message ID (NO at S2202), the communication node PDG-A notifies the PDG managing server that a new address change request message has been received (S2204). The PDG managing server then checks whether any of the communication nodes PDG has already sent an address change request message to the communication partner node (UE) and is in a response waiting state (S2205). When no communication node PDG is in the response waiting state (NO at S2205), the PDG managing server judges whether to send an address change request of the communication node PDG simultaneously with the address change request from the communication partner node (UE) (S2206). When the address change is not simultaneously performed (NO at S2206), the PDG managing server makes the communication node PDG-A send a response message to the address change request message from the communication partner node (UE) (S2207).

The communication node PDG-A performs the SA address change process (S2208). The communication node PDG-A then generates the response message and sends the response message to the communication partner node (UE) (S2009). When the PDG managing server decides to simultaneously perform the address change (YES at S2206), the PDG managing server selects the communication node PDG to which the switch is made (S2210). Here, it is assumed that the communication node PDG is switched to a communication node PDG-B. The PDG managing sever notifies the PDG-B that the address change request has been received from the communication partner node (UE) and makes the PDG-B to send an address change request to the communication partner node (UE) (S2211). The communication node PDG-B generates a message to which REPLY(msgID_UE2) is added and sends the message to the communication partner node (UE) (S2212).

Next, when any of the communication nodes PDG (PDG-B, in this instance) has already sent an address change request message to the communication partner node (UE) and is in a response waiting state (YES at S2205), the PDG managing server notifies the communication node PDG-B that the address change request has been received from the communication partner node (UE) (S2213). The communication node PDG-B checks whether REPLY(msgID_PDG) is included in the address change request message received from the communication partner node (UE) (S2214). When REPLY(msgID_PDG) is not included (NO at S2214), the communication node PDG-B generates a message to which REPLY(msgID_UE2) and REQUEST(msgID_PDG) are added, and sends the message to the communication partner node (UE) (S2215).

When REPLY(msgID_PDG) is included in the address change request message sent from the communication partner node (UE) (YES at S2214), the communication node PDG-B ends the response waiting state for the address change request message having the message ID (msgID_PDG) (S2216). When the response does not arrive while the communication node PDG-B is in the response waiting state, the communication node is required perform a process, such as re-sending the address change request message. Therefore, when the response is received, the communication node is required to be released from this state.

Next, the communication node PDG-B checks whether REQUEST(msgID_UE1) is included in the address change request message sent form the communication partner node (UE) (S2217). When the REQUEST(msgID_UE1) is not included (NO at S2217), the communication node PDG-B performs the SA address change process in adherence to the address change request message sent from the communication partner node (UE) (S2218). The communication node PDG-B creates a response message and sends the response message to the communication partner node (UE) (S2219). When the REQUEST(msgID_UE1) is included (YES at S2217), the communication node PDG-B checks whether the message ID (msgID_UE1) is the same as a previously received message ID (S2220). A source address of the message is also used to check the message ID.

When the message ID (msgID_UE1) does not match a previously received message ID and is a new message ID (NO at S2220), the communication node PDG-B performs the SA address change process in adherence to the address change request message sent from the communication partner node (UE) (S2218). The communication node PDG-B generates the response message and sends the response message to the communication partner node (UE) (S2219). When the message ID (msgID_UE1) is a previously received message ID (YES at S2220), the communication node PDG-B performs the SA address change process (S2221) and notifies the PDG managing server that the address change process has been completed (S2222). A processing flow of when the communication node PDG (PDG-A) receives the address change request message from the communication partner node (UE) is as described above.

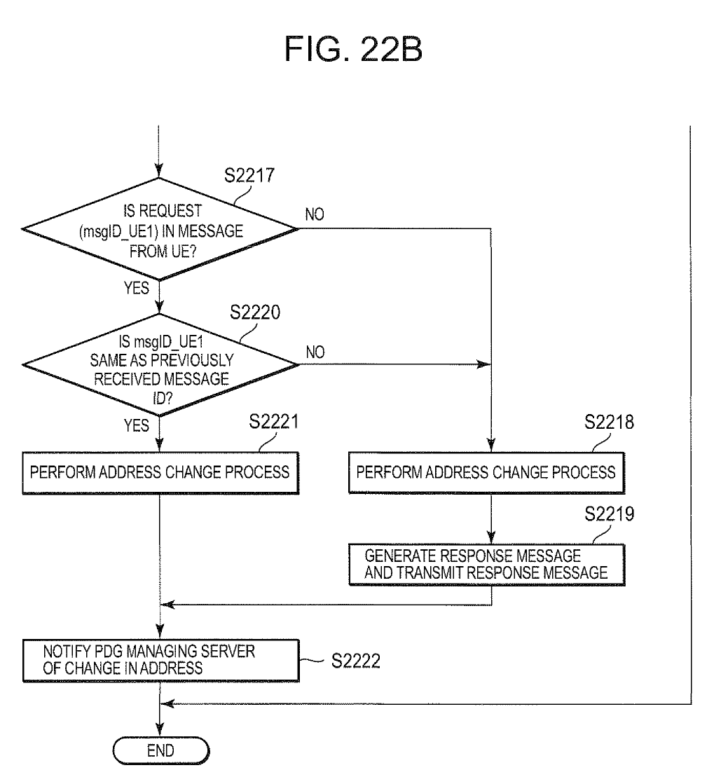

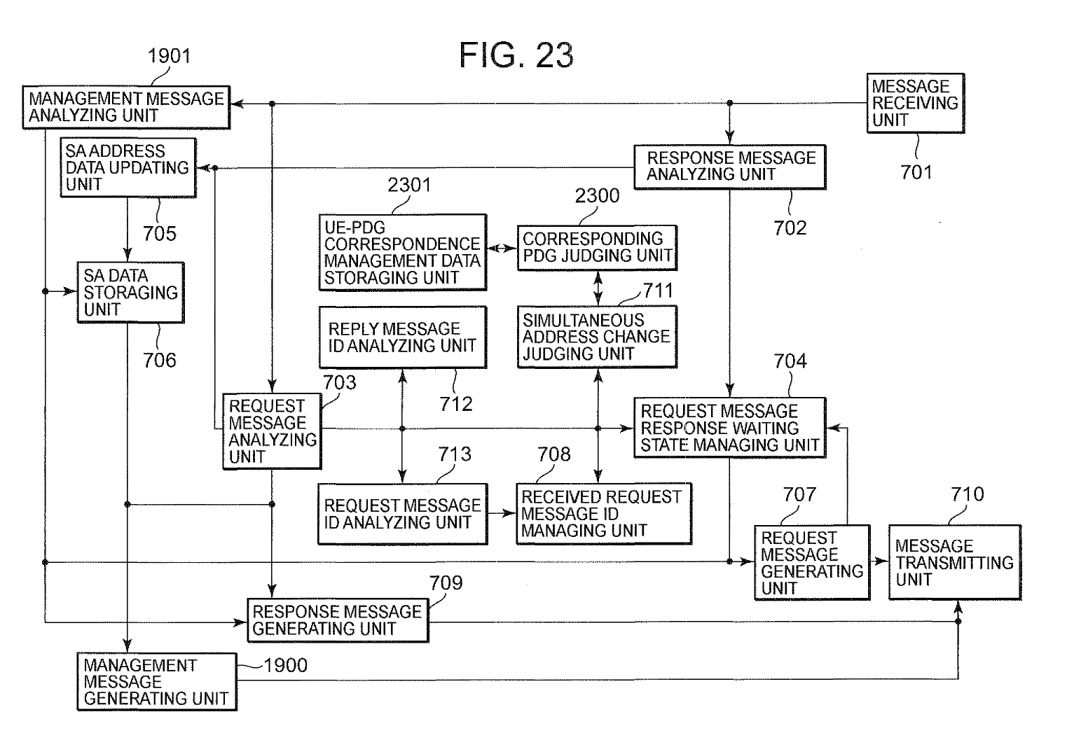

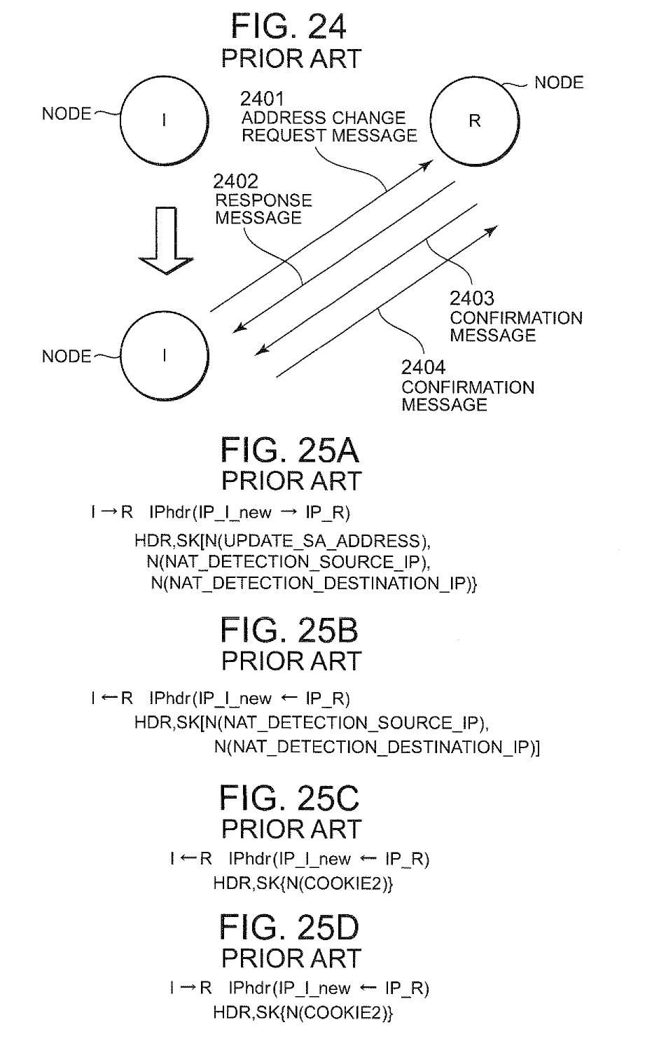

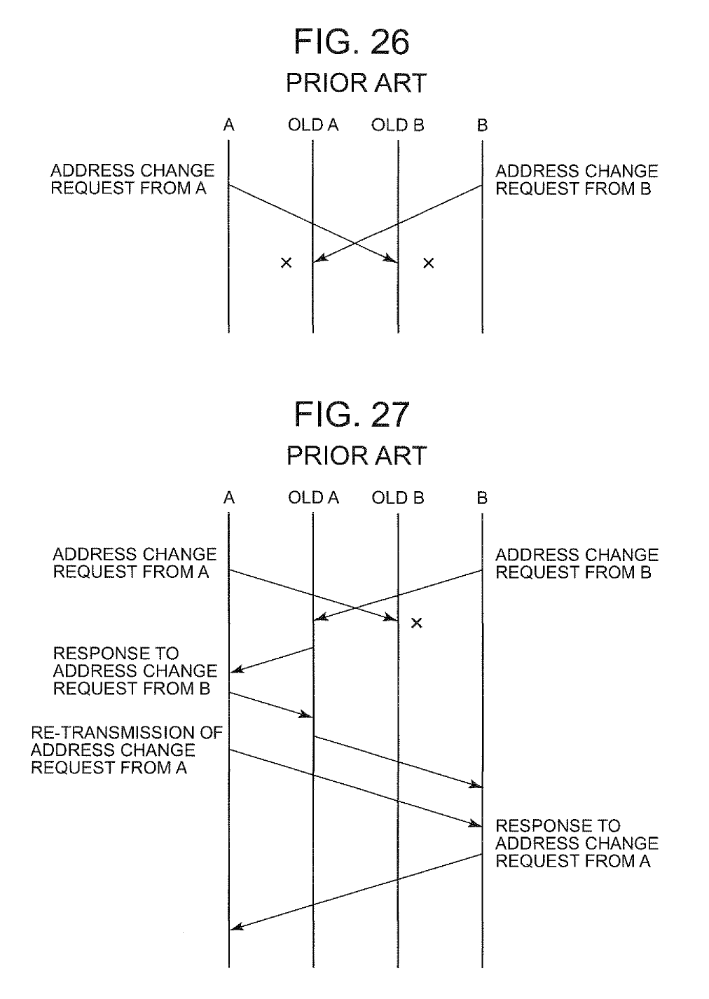

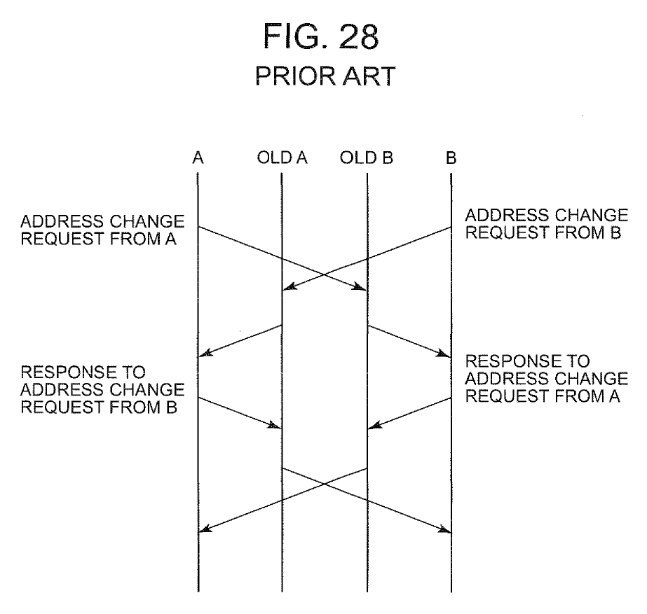

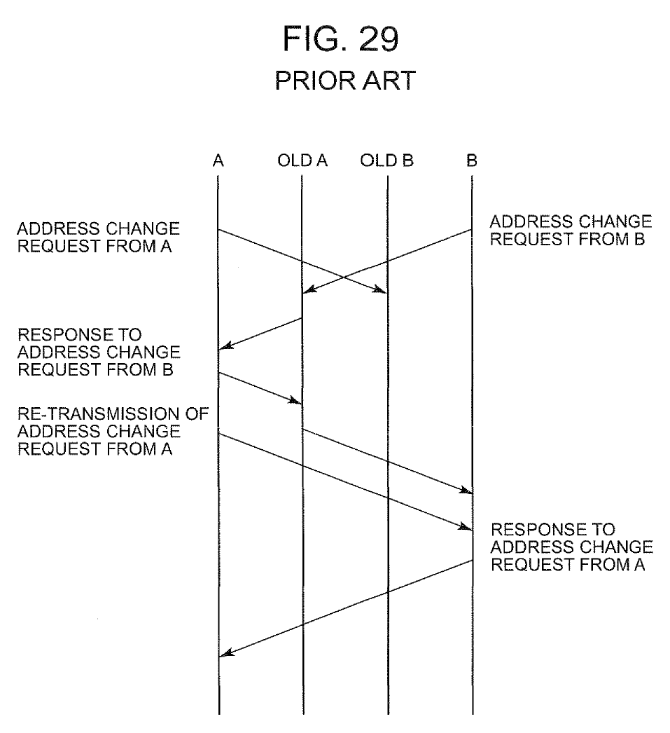

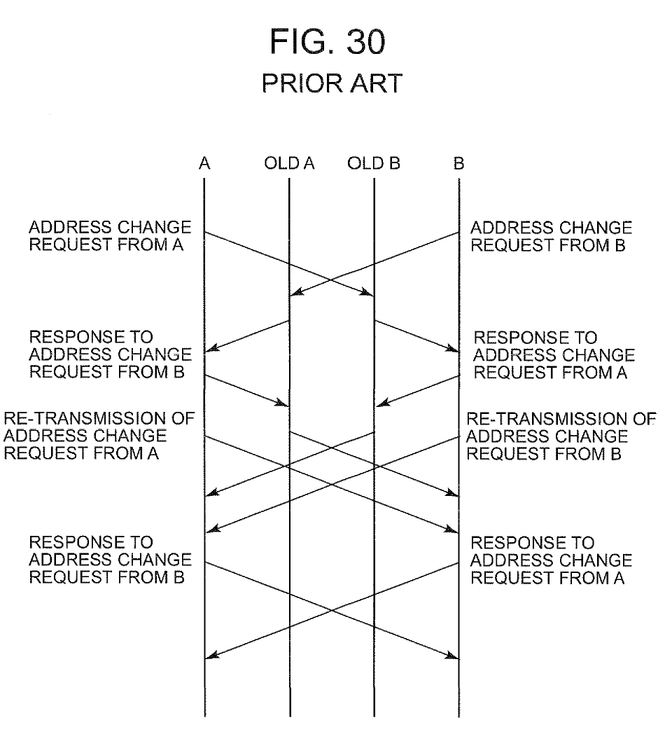

Operations related to the PDG and the PDG managing server are described above. Here, when the PDG and the PDG managing server are separate is described. However, the same applies when the PDG server is not present. In this instance, a pre-change PDG directly sends a message to a post-change PDG. The pre-change PDG itself holds information required to select the post-change PDG. An example in which the PDG has a corresponding PDG judging unit 2300 and a UE-PDG correspondence management data storaging unit 2301 as constituent elements is shown in FIG. 23.

The corresponding PDG judging unit 2300 judges whether to prompt the UE 1202 to perform PDG change in accompaniment with the address change request from the UE 1202, or it judges whether to change PDG initiately by the PDG. The UE-PDG correspondence management data storaging unit 2301 is a functional unit that performs information exchange regarding the state of each PDG and storages data indicating the states for the purpose of dispersing load among PDG and optimizing a packet path for communication with the UE 1202.

The corresponding PDG judging unit 2300 judges whether to change the PDG and to which PDG the change is made using the data in the UE-PDG correspondence management data storaging unit 2301. The corresponding PDG judging unit 2300 is considered as an extension of judging conditions of the simultaneous address change judging unit 711. The corresponding PDG judging unit 2300 differs from the simultaneous address change judging unit 711 in that whether the address change is simultaneously performed is judged also taking into consideration communication states of other terminals in addition to its own terminal.

Here, when the PDG is changed is described. However, similar processes can be performed when the UE switches devices. For example, when a compact mobile returns home from an outside location, the UE may switch from the compact mobile terminal that is convenient to carry to a large-scale terminal, such as a television or a stereo system, that reproduces high-quality images and sound. Alternatively, when a battery of a mobile terminal runs low, the UE may switch to a sufficiently charged mobile terminal.

In a more specific example, a following application can be considered. When the battery runs low while a service, such as a call, is continued, the service can be continued using another terminal having a sufficiently charged battery. The original mobile terminal of which the battery has run low can be connected to a charger. Moreover, applications such as when a mobile phone is replaced, or exchanged with a new mobile phone can be considered. At this time, when application is not limited to the PDG, the corresponding PDG judging unit 2300 in the block diagram in FIG. 23 can be referred to instead as a corresponding terminal judging unit for convenience. The UE-PDG correspondence management data storaging unit 2301 can be referred to instead as a terminal-terminal correspondence management data storaging unit.

Each functional block used in the explanations of each embodiment of the present embodiment, described above, can be realized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed after LSI manufacturing or a reconfigurable processor of which connections and settings of the circuit cells within the LSI can be reconfigured can be used. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The communication continuing method and the communication terminal device used in the method of the present invention can shorten an amount of time required to complete message exchange for changing addresses of both ends of the SA, and efficiently perform the message exchange, without increasing the number of messages. In addition, the communication continuing message and the communication terminal used in the method can facilitate collective changing of the addresses of both ends at once, and efficiently actualize the SA address change operation in a terminal. Therefore, the communication continuing method and the communication terminal device used in the method of the present invention is useful in a communication continuing method and the communication terminal device used in the method in which, when an address changes as a result of movement of a communication terminal device after security information used to establish a secure communication path between communication terminal devices is generated, communication between the communication terminal devices after the movement is continued using the security information generated before the movement.

1. A communication continuing method in which, when addresses change as a result of movement of the first communication terminal and the second communication terminal after security information used to establish a secure communication path between the first communication terminal and the second communication terminal is generated, communication between the first communication terminal and the second communication terminal after the movement is continued using the security information generated before the movement, the communication continuing method comprising a step of:
sending, by the second communication terminal, the first message to the first communication terminal in accompaniment with movement of the second communication terminal itself, the first message requesting an update of an address in the security information held by the first communication terminal; and
sending, by the first communication terminal, the second message to the second communication terminal in accompaniment with movement of the first communication terminal itself and, when the first message is received before a response to the second message is received, sending the third message to the address of the second communication terminal after movement, the second message requesting an update of an address in the security information held by the second communication terminal, and the third message requesting an update of an address in the security information held by the second communication terminal.

2. The communication continuing method according to claim 1, wherein the third message includes information stating that the third message is a re-sending of the second message, information stating that the third message is a response to the first message, and information stating that the third message is a new message requesting an update of an address in the security information held by the second communication terminal.

3. A communication continuing method in which, when addresses change as a result of movement of the first communication terminal and the second communication terminal after security information used to establish a secure communication path between the first communication terminal and the second communication terminal is generated, communication between the first communication terminal and the second communication terminal after the movement is continued using the security information generated before the movement, the communication continuing method comprising a step of:
sending, by the second communication terminal, the first message to the first communication terminal in accompaniment with movement of the second communication terminal itself, the first message requesting an update of an address in the security information held by the first communication terminal;
sending, by the first communication terminal, the second message to the address of the second communication terminal after movement based on the first message, the second message requesting an update of an address in the security information held by the second communication terminal; and
deciding, by the second communication terminal, to not perform a response process for the second message when the third message requesting an update of an address in the security information held by the second communication terminal is already received from the first communication terminal when the second message is received, and processes the second message as a response to the first message.

4. The communication continuing method according to claim 3, wherein the second communication terminal generates a response message based on the second message and sends the generated response message to an address of the first communication terminal after movement, when the third message has not been received from the first communication terminal when the second message is received.

5. A communication continuing method in which, when addresses change as a result of movement of the first communication terminal and the second communication terminal after security information used to establish a secure communication path between the first communication terminal and the second communication terminal is generated, communication between the first communication terminal and the second communication terminal after the movement is continued using the security information created before the movement, the communication continuing method comprising a step of:
sending, by the second communication terminal, the first message to the first communication terminal in accompaniment with movement of the second communication terminal itself, the first message requesting an update of an address in the security information held by the first communication terminal; and
sending, by the first communication terminal, the second message to the address of the second communication terminal after movement based on the first message, the second message requesting an update of an address in the security information held by the second communication terminal.

6. The communication continuing method according to claim 5, wherein the second message includes information stating that the second message is a response to the first message.

7. The communication continuing method according to claim 5, wherein the second message includes information stating that the request to update the address made by the first message is rejected.

8. The communication continuing method according to claim 5, wherein the second message does not include information related to the first message.

9. A communication continuing method in which, when an address changes as a result of movement of the second communication terminal after security information used to establish a secure communication path between the first communication terminal capable of multi-linking and the second communication terminal is generated, communication between the first communication terminal and the second communication terminal after the movement is continued using the security information generated before the movement, the communication continuing method comprising a step of:
sending, by the second communication terminal, the first message to the first communication terminal in accompaniment with movement of the second communication terminal itself, the first message requesting an update of an address in the security information held by the first communication terminal; and
deciding, by the first communication terminal, whether to update the address in the security information held by the first communication terminal based on the first message and, when the address is updated, updating the address in the security information held by the first communication terminal, and sending the second message to the address of the second communication terminal after movement, the second message requesting an update of an address in the security information held by the second communication terminal.

10. The communication continuing method according to claim 9, wherein the second message includes information stating that the second message is a response to the first message.

11. The communication continuing method according to claim 9, wherein the second message includes information stating that the request to update the address made by the first message is rejected.

12. The communication continuing method according to claim 9, wherein the second message does not include information related to the first message.

13. A communication terminal that is a predetermined communication terminal used in a communication continuing method in which, when addresses change as a result of movement of the predetermined communication terminal and a partner communication terminal communicating with the predetermined communication terminal after security information used to establish a secure communication path between the predetermined communication terminal and the partner communication terminal is generated, communication between the predetermined communication terminal and the partner communication terminal after the movement is continued using the security information generated before the movement, the communication terminal comprising:
a receiving means for receiving the first message from the partner communication terminal, the first message requesting an update of an address in the security information held by the predetermined communication terminal itself;
a request message generating means for generating the second message in accompaniment with movement of the predetermined communication terminal itself, the second message requesting an update of an address in the security information held by the partner communication terminal; and
a sending means for sending the generated second message to the address of the partner communication terminal before movement,
wherein, when the first message is received via the receiving means before a response to the second message is received,
the request message generating means generates the third message requesting an update of an address in the security information held by the partner communication terminal, and
the sending means sends the generated third message to the address of the partner communication terminal after movement.

14. The communication terminal according to claim 13, wherein the third message includes information stating that the third message is a re-sending of the second message, information stating that the third message is a response to the first message, and information stating that the third message is a new message requesting an update of an address in the security information held by the partner communication terminal.

15. A communication terminal that is a predetermined communication terminal used in a communication continuing method in which, when addresses change as a result of movement of the predetermined communication terminal and a partner communication terminal communicating with the predetermined communication terminal after security information used to establish a secure communication path between the predetermined communication terminal and the partner communication terminal is generated, communication between the predetermined communication terminal and the partner communication terminal after the movement is continued using the security information generated before the movement, the communication terminal comprising:
a request message generating means for generating the first message in accompaniment with movement of the predetermined communication terminal itself, the first message requesting an update of an address in the security information held by the partner communication terminal;
a sending means for sending the generated first message to the partner communication terminal;
a receiving means for receiving the second message sent by the partner communication terminal based on the first message, the second message requesting an update of an address in the security information held by the predetermined communication terminal; and
a processing means for deciding not to perform a response process for the second message when the third message requesting an update of an address in the security information held by the predetermined communication terminal is already received from the partner communication terminal when the second message is received via the receiving means, and processing the second message as a response to the first message.

16. The communication terminal according to claim 15, further comprising:
a response message generating means for generating a response message based on the second message, when the third message has not been received from the partner communication terminal when the second message is received via the receiving means,
wherein the sending means sends the generated response message to the address of the partner communication terminal after movement.

17. A communication terminal that is a predetermined communication terminal used in a communication continuing method in which, when addresses change as a result of movement of the predetermined communication terminal and a partner communication terminal communicating with the predetermined communication terminal after security information used to establish a secure communication path between the predetermined communication terminal and the partner communication terminal is generated, communication between the predetermined communication terminal and the partner communication terminal after the movement is continued using the security information generated before the movement, the communication terminal comprising:
a receiving means for receiving the first message from the partner communication terminal, the first message requesting an update of an address in the security information held by the predetermined communication terminal itself;
a request message generating means for generating the second message based on the received first message, the second message requesting an update of an address in the security information held by the partner communication terminal; and
a sending means for sending the generated second message to the address of the partner communication terminal after movement.

18. The communication terminal according to claim 17, wherein the second message includes information stating that the second message is a response to the first message.

19. The communication terminal according to claim 17, wherein the second message includes information stating that the request to update the address made by the first message is rejected.

20. The communication terminal according to claim 17, wherein the second message does not include information related to the first message.

21. A communication terminal that is a predetermined communication terminal used in a communication continuing method in which, when addresses change as a result of movement of the predetermined communication terminal capable of multi-linking and a partner communication terminal communicating with the predetermined communication terminal after security information used to establish a secure communication path between the predetermined communication terminal and the partner communication terminal is generated, communication between the predetermined communication terminal and the partner communication terminal after the movement is continued using the security information created before the movement, the communication terminal comprising:
a receiving means for receiving the first message from the partner communication terminal, the first message requesting an update of an address in the security information held by the predetermined communication terminal itself;
a deciding means for deciding whether to update the address in the security information held by the predetermined communication terminal itself, based on the received first message;
an updating means for updating the address in the security information held by the predetermined communication terminal itself, when a decision is made to update the address;
a request message generating means for generating the second message requesting an update of an address in the security information held by the partner communication terminal; and
a sending means for sending the generated second message to the address of the partner communication terminal after movement.

22. The communication terminal according to claim 21, wherein the second message includes information stating that the second message is a response to the first message.

23. The communication terminal according to claim 21, wherein the second message includes information stating that the request to update the address made by the first message is rejected.

24. The communication terminal according to claim 21, wherein the second message does not include information related to the first message.

25. A communication continuing method in which, when an address changes as a result of movement of the first communication terminal after security information used to establish a secure communication path between the first communication terminal and the second communication terminal is generated, the first communication terminal continues communication via the third communication terminal using the security information before movement, the communication continuing method comprising a step of:
sending, by the first communication terminal, the first message to the second terminal, the first message requesting an update of an address in the security information held by the second communication terminal; and
sending, by the third communication terminal, the second message to an address of the first communication terminal after movement, based on the first message received by the second communication terminal, the second message requesting an update of the address in the security information held by the first communication terminal.

26. The communication continuing method according to claim 25, further comprising a step of:
sending, by the third communication terminal, the third message requesting an update of an address in the security information held by the first communication terminal to the first communication terminal before movement, when the first communication terminal sends the first message to the second communication terminal,
wherein the third communication terminal includes identifying information of the third message in the second message and sends the second message.

27. The communication continuing method according to claim 26, wherein:
when the third message sent by the third communication terminal is forwarded to the first communication terminal after movement,
the first communication terminal sends to the third communication terminal the fourth message stating that the fourth message is a response to the third message and is a request to update an address.

28. A communication terminal that is a predetermined communication terminal used in a communication continuing method in which, when an address changes as a result of movement of the predetermined communication terminal after security information used to establish a secure communication path between the predetermined communication terminal and the first partner communication terminal is generated, the predetermined communication terminal continues communication via the second partner communication terminal using the security information before movement, the communication terminal comprising:
a message generating means for generating the first message requesting an update of an address in the security information held by the first partner communication terminal;
a sending means for sending the generated first message to the first partner communication terminal; and
a receiving means for receiving the second message sent by the second partner communication terminal based on reception of the first message by the first partner communication terminal, the second message requesting an update of the address in the security information held by the predetermined communication terminal.

29. The communication terminal according to claim 28, wherein:
the receiving means receives the third message sent by the second partner communication terminal at a movement destination when the first message is sent by the sending means, the third message requesting an update of an address in the security information held by the predetermined communication terminal,
the message generating means generates the fourth message stating that the fourth message is a response to the third message and is a request to update an address, and
the sending means sends the generated fourth message to the second partner communication terminal.
